(19) United States
(12) Patent Application Publication
(10) Pub. No.: US 2025/0155958 A1
(43) Pub. Date: May 15, 2025

(54) METHODS AND APPARATUS FOR POWER SAVING MODE

(71) Applicant: Texas Instruments Incorporated, Dallas, TX (US)

(72) Inventors: Joerg Kirchner, Mauern (DE); Florian Neveu, Neufahrn (DE); Stefan Schimonsky, MUENCHEN, (DE)

(21) Appl. No.: 18/428,220

(22) Filed: Jan. 31, 2024

Related U.S. Application Data
(60) Provisional application No. 63/599,318, filed on Nov. 15, 2023.

(51) Int. Cl. G06F 1/3296

(52) U.S. Cl. CPC G06F 1/3296

(57) ABSTRACT

An example apparatus includes: switching converter circuitry having an input terminal and an output terminal; and peak current control circuitry coupled to the switching converter circuitry, the peak current control circuitry including: error amplifier having an input terminal and an output terminal; power saving mode (PSM) entry circuitry having a first input terminal, a second input terminal, and an output terminal, the first input terminal of the PSM entry circuitry coupled to the input terminal of the switching converter circuitry, the second input terminal of the PSM entry circuitry coupled to the output terminal of the switching converter circuitry and the input terminal of the error amplifier; and comparison circuitry having a first input terminal and a second input terminal, the first input terminal of the comparison circuitry coupled to the output terminal of the error amplifier.

### CROSS-REFERENCE TO RELATED APPLICATION

This patent application claims the benefit of and priority to U.S. Provisional Patent Application No. 63/599,318 filed Nov. 15, 2023, which application is hereby incorporated herein by reference in its entirety.

### TECHNICAL FIELD

This description relates generally to switching power converters and, more particularly, to methods and apparatus for power saving mode.

### BACKGROUND

Continuing advancements in electronics allow circuitry to perform increasingly complex operations, while consuming less overall power. As electronics continue to advance, designers are incentivized to develop switching power converter circuitry that reliably and efficiently operates across a wide range of operating conditions. For example, buck-boost converter circuitry may generate output voltages that are less than the input voltage or greater than the input voltage. In both conditions, the buck-boost converter circuitry regulates the output voltage to account for variations in the input voltage, such as the discharge of a battery.

### SUMMARY

One general aspect includes switching converter circuitry having an input terminal and an output terminal; and peak current control circuitry coupled to the switching converter circuitry, the peak current control circuitry including: error amplifier having an input terminal and an output terminal; power saving mode (PSM) entry circuitry having a first input terminal, a second input terminal, and an output terminal, the first input terminal of the PSM entry circuitry coupled to the input terminal of the switching converter circuitry, the second input terminal of the PSM entry circuitry coupled to the output terminal of the switching converter circuitry and the input terminal of the error amplifier; and comparison circuitry having a first input terminal and a second input terminal, the first input terminal of the comparison circuitry coupled to the output terminal of the error amplifier, the second input terminal of the comparison circuitry coupled to the output terminal of the PSM entry circuitry. Other embodiments of this aspect include corresponding computer systems, apparatus, and computer programs recorded on one or more computer storage devices, each configured to perform the actions of the methods.

One general aspect includes an error amplifier having an input terminal and an output terminal; power saving mode (PSM) entry circuitry coupled to the error amplifier, the PSM entry circuitry including: comparison circuitry having an input terminal and an output terminal, the input terminal of the comparison circuitry adaptive to be coupled to the input terminal of the error amplifier; scaling circuitry having an input terminal and an output terminal, the input terminal of the scaling circuitry coupled to the output terminal of the comparison circuitry; and offset circuitry having an input terminal and an output terminal, the input terminal of the offset circuitry coupled to the output terminal of the scaling circuitry; and comparison circuitry having a first input terminal and a second input terminal, the first input terminal of the comparison circuitry coupled to the output terminal of the error amplifier, the second input terminal of the comparison circuitry coupled to the output terminal of the offset circuitry. Other embodiments of this aspect include corresponding computer systems, apparatus, and computer programs recorded on one or more computer storage devices, each configured to perform the actions of the methods.

One general aspect includes switching converter circuitry configured to generate an output voltage responsive to an input voltage; power saving mode (PSM) entry circuitry coupled to the switching converter circuitry, the PSM entry circuitry including: comparison circuitry coupled to the switching converter circuitry, the comparison circuitry configured to compare the input voltage and the output voltage to select one of the input voltage or the output voltage; scaling circuitry coupled to the comparison circuitry, the scaling circuitry configured to scale the one of the input voltage or the output voltage by a slope constant of the switching converter circuitry; and offset circuitry coupled to the scaling circuitry, the offset circuitry configured to offset a reference compensation voltage by the one of the input voltage or the output voltage to generate a PSM entry voltage; and comparison circuitry coupled to the offset circuitry, the comparison circuitry configured to compare a compensation voltage to the PSM entry voltage, the compensation voltage represents an error between the output voltage of the switching converter circuitry and a reference voltage. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a block diagram of an example system in which example converter circuitry regulates a supply of power from a power source to supply power to a universal serial bus (USB) port.

FIG. 2 is a block diagram of an example vehicle including an example universal serial bus (USB) electronic control unit (ECU) having converter circuitry that supplies power to a USB port.

FIG. 3 is a schematic diagram of an example of the converter circuitry of FIG. 2 including example peak current control circuitry to control power saving mode (PSM) entry of the converter circuitry.

FIG. 4 is a schematic diagram of an example of the peak current control circuitry of FIG. 3 including example PSM entry circuitry, which determines a PSM entry responsive to an input voltage, an output voltage, and a slope constant of the converter circuitry of FIGS. 1, 2, and 3.

FIG. 5 is a schematic diagram of an example of the PSM entry circuitry of FIG. 4.

FIG. 6 is a schematic diagram of another example of the PSM entry circuitry of FIG. 4.

FIG. 7 is a plot of example ripple current of the converter circuitry of FIGS. 1, 2, and 3 and the PSM entry circuitry of FIGS. 4, 5, and 6.

FIG. 8 is a plot of example operations of the PSM entry circuitry of FIGS. 4, 5, and 6.

FIG. 9 is a plot of an example derating of an inductance of the converter circuitry of FIGS. 1, 2, and 3 over current.

FIG. 10 is a timing diagram of example boost operations of the converter circuitry of FIGS. 1, 2, and 3.

FIG. 11 is a timing diagram of example buck operations of the converter circuitry of FIGS. 1, 2, and 3.

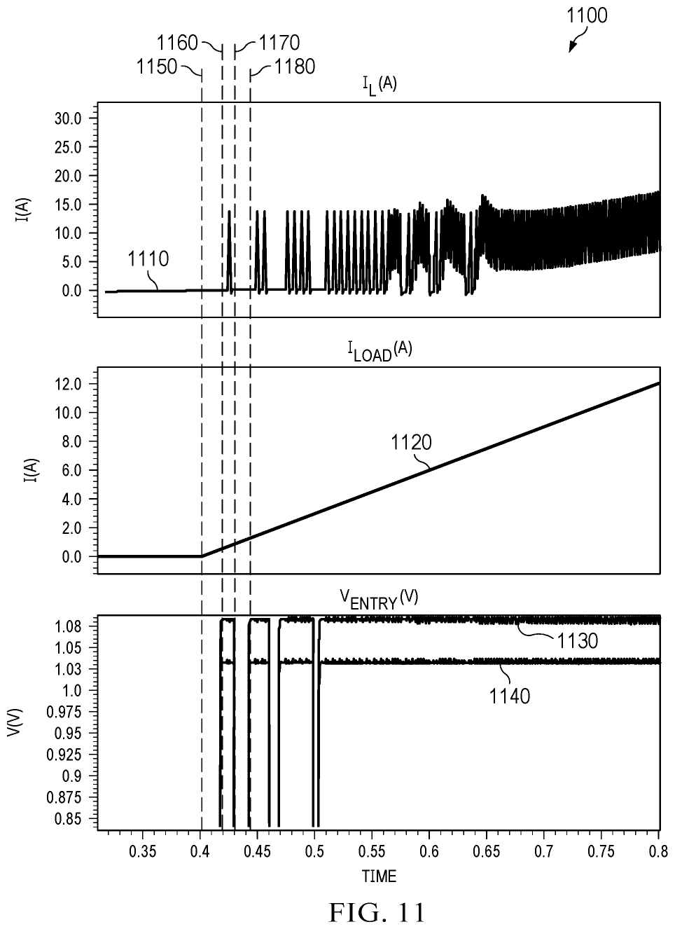

FIG. 12 is a flowchart representative of example operations that may be executed, instantiated, and/or performed to implement PSM entry circuitry of FIGS. 4, 5, and 6 to generate a PSM entry point responsive to an input voltage and an output voltage of the converter circuitry of FIGS. 1, 2, and 3.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Continuing advancements in electronics allow circuitry to perform increasingly complex operations, while consuming less overall power. As electronics continue to advance, designers are incentivized to develop switching converter circuitry that reliably and efficiently operates across a wide range of operating conditions. For example, buck-boost converter circuitry may generate output voltages that are less than an input voltage or greater than the input voltage. In both conditions, the buck-boost converter circuitry regulates the output voltage to account for variations in the input voltage, such as the discharge of a battery.

Switching converter circuitry regulates the flow of current through an inductor to generate an output voltage. Such switching converter circuitry switches between supplying current to the inductor (e.g., charging the inductor) and allowing the inductor to supply current (e.g., discharging the inductor). The rate at which the switching converter circuitry switches between operations is referred to as a switching frequency (f_{S}). However, switching between charging and discharging the inductor results in a current ripple. The magnitude of the current ripple depends on the switching frequency, the inductance of the inductor, and a current limit of the converter circuitry. Relatively large current ripple decreases efficiency and reduces reliability of the switching converter circuitry.

Some switching converter circuitry modifies operating conditions to improve power efficiency and reliably perform switching operations. One such set of operating conditions is referred to as power saving mode (PSM). In PSM, the switching converter circuitry may decrease the switching frequency or skip one or more switching cycles to increase power efficiency by keeping the inductor near boundary conduction. Boundary conduction occurs between a continuous conduction mode and a discontinuous conduction mode of operation. In continuous conduction mode, the current through the inductor remains above zero during switching operations. In discontinuous conduction mode, during switching operations the current through the inductor settles to zero. Such switching converter circuitry uses a PSM entry value to represent a threshold condition that identifies when to enter PSM. The PSM entry value represents a value resulting from a comparison of the current limit (e.g., peak current), which corresponds to the boundary conduction of the inductor, to a PSM entry current. Accordingly, the PSM entry value represents a portion of the current limit corresponding to the PSM entry current. When the current through the inductor satisfies the threshold condition of the PSM entry value, the switching converter circuitry enters PSM.

The PSM entry current is proportional to the input and output voltage, the switching frequency, the inductance of the inductor, and/or the current limit. An example determination of the PSM entry current is further described below. In some examples, the switching converter circuitry uses a predetermined PSM entry value, which reflects a predetermined PSM entry current, to detect PSM entry. Such a predetermined PSM entry value is a fixed value which does not adjust to modifications in the input and output voltages of the switching circuitry.

In a first example system, which uses a large inductor, has a relatively low switching frequency, and a relatively large current limit, the PSM entry value is relatively low (e.g., a relatively small portion of the current limit). In a second example system, which uses a small inductor, has a relatively high switching frequency, and a relatively low current limit, the PSM entry value is relatively high (e.g., a relatively large portion of the current limit). However, variations in the components and operating conditions of the switching converters may modify the ripple current of the inductor, which changes the ideal value of the PSM entry value. Alternatively, changing operations of the switching converter circuitry, such as switching from buck operations to boost operations, may substantially modify the PSM entry value. Such limitations may prevent the use of PSM in switching converter circuitry.

Examples described here include methods and apparatus to control power saving mode entry in switching converter circuitry. In some described examples, the switching converter circuitry includes peak current control circuitry, which further includes PSM entry circuitry. The PSM entry circuitry determines a PSM entry voltage of the switching converter circuitry based on the input and output voltages, a slope constant, and a reference compensation voltage. The PSM entry voltage is a voltage representation of the PSM entry current. In such examples, the PSM entry circuitry includes comparison circuitry, scaling circuitry, and offset circuitry. The comparison circuitry determines whether the converter circuitry is in the buck or boost mode of operation responsive to comparing the input and output voltages of the converter circuitry. The output of the comparison circuitry is proportional to the greater of the input voltage or the output voltages. The scaling circuitry scales the output of the comparison circuitry using the slope constant to compensate for the slope of the inductor current. The offset circuitry generates the PSM entry voltage by offsetting the reference compensation voltage based on the magnitude of the compensated output of the comparison circuitry.

In operation, the PSM entry circuitry accounts for changes in the input voltage and/or the output voltage when determining the PSM entry voltage. The peak current control circuitry generates the PSM entry value responsive to a comparison of the PSM entry voltage to the compensation voltage, which represents the current limit of an inductor of the converter circuitry, determined by comparing the output voltage to the reference output voltage. In such example operations, the PSM entry value represents an output of a comparison of the inductor current to a peak current. The switching converter circuitry enters PSM responsive to the ripple current through the inductor corresponding to the threshold condition represented by the PSM entry value. Advantageously, the peak current control circuitry dynamically determines the PSM entry value based on the operations of the converter circuitry.

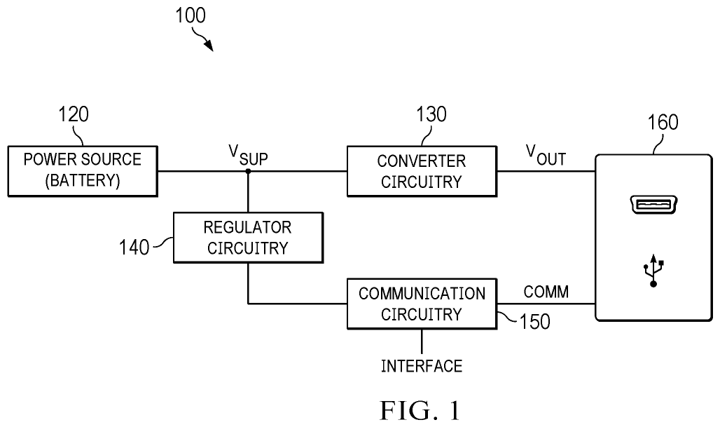

FIG. 1 is a block diagram of an example system 100. In the example of FIG. 1, the system 100 includes a power source 120, converter circuitry 130, regulator circuitry 140, communication circuitry 150, and a USB port 160.

The power source 120 is coupled to the converter circuitry 130 and the regulator circuitry 140. The power source 120 supplies a supply voltage to the converter circuitry 130 and the regulator circuitry 140. In some examples, the power source 120 is an energy storage device, such as a battery. In such examples, the supply voltage decreases as the energy storage device discharges. In one example, when the power source 120 is fully charged, the supply voltage is approximately twelve and a half volts (V). However, when the power source 120 is almost fully discharged, the supply voltage is approximately equal to eleven and a half volts. In another example, when the power source 120 is fully charged, the supply voltage is approximately five and a half volts (V). However, when the power source 120 is almost fully discharged, the supply voltage is approximately equal to one and four-tenths volts. In such examples, the converter circuitry 130 and the regulator circuitry 140 account for variations in the supply voltage as the power source 120 discharges.

The converter circuitry 130 has an input terminal coupled to the power source 120 and the regulator circuitry 140 and an output terminal coupled to the USB port 160. The converter circuitry 130 receives the supply voltage from the power source 120 as an input voltage (VIN). The converter circuitry 130 generates an output voltage (VOUT) responsive to the input voltage. In some examples, the converter circuitry 130 generates the output voltage that is less than the input voltage. In such examples, the converter circuitry 130 is referred to as buck converter circuitry. In other examples, the converter circuitry 130 generates the output voltage that is greater than the input voltage. In such examples, the converter circuitry 130 is referred to as boost converter circuitry. In yet another example, the converter circuitry 130 is capable of generating the output voltage that is both greater than and less than the input voltage. In such examples, the converter circuitry 130 is referred to as buck-boost converter circuitry.

In some examples, the converter circuitry 130 utilizes switching to control current through an inductance. During some operations, the converter circuitry 130 charges the inductor responsive to coupling the inductance to the input voltage, which generates a current in a first direction. During other operations, the converter circuitry 130 allows the inductance to discharge responsive to couple the inductance to a common potential, which generates a current in a second direction. In such examples, switching the supply of current to the inductance using switches allows the converter circuitry 130 to generate the output voltage.

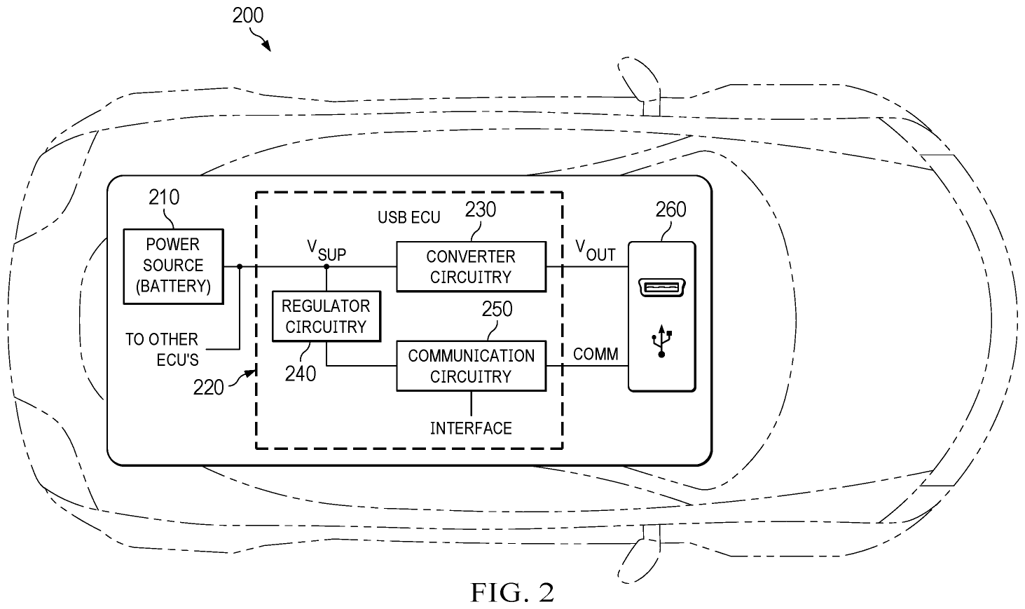

In some examples, such as in FIG. 2, below, the converter circuitry 130 includes safety circuitry, such as fuse circuitry, to prevent a supply of power to the USB port 160 responsive to a fault condition being met. A fault condition occurs responsive to a determination that one or more values (e.g., voltages, currents, etc.) are improperly set. When a fault condition occurs, the converter circuitry 130 asserts a fault condition to initialize safety operations. In such example conditions, the converter circuitry 130 reduces a likelihood of being exposed to harmful operating conditions. In some examples, the converter circuitry 130 controls fuse circuitry to prevent the power source 120 from supplying power to one or more components of the converter circuitry 130. In such examples, the converter circuitry 130 disables the supply of power to the one or more components responsive to detection of a fault condition. An example of the converter circuitry 130 is illustrated and described in connection with FIG. 2, below.

The regulator circuitry 140 has an input terminal coupled to the power source 120 and the converter circuitry 130 and an output terminal coupled to the communication circuitry 150. The regulator circuitry 140 receives the supply voltage from the power source 120. The regulator circuitry 140 regulates a supply of power from the power source 120 to supply an output voltage (VOUT) to the communication circuitry 150. In some examples, the regulator circuitry 140 uses feedback loops to generate the output voltage. For example, the regulator circuitry 140 may be linear regulator circuitry, which utilizes an error amplifier, a transistor, and resistor ladder to generate the output voltage. In such examples, the error amplifier regulates the current trough the transistor responsive to feedback from the resistor ladder. The regulator circuitry 140 supplies the output voltage to the communication circuitry 150.

The communication circuitry 150 has a first terminal coupled to the regulator circuitry 140, a second terminal coupled to the USB port 160, and a third terminal that may be coupled to external circuitry, which interfaces with the USB port 160 by the communication circuitry 150. The communication circuitry 150 receives the output voltage from the regulator circuitry 140 as a supply voltage. The communication circuitry 150 implements USB communication protocols to allow external circuitry, coupled to the USB port 160, to communicate with the vehicle 100. In some examples, the communication circuitry 150 is coupled to other ECUs to allow the external circuitry to interface with one or more operations of the vehicle 100. For example, the communication circuitry 150 facilitates communications between external circuitry and an audio ECU to play audio from the external circuitry.

The USB port 160 has a first terminal coupled to the converter circuitry 130 and a second terminal coupled to the communication circuitry 150. The USB port 160 couples the USB ECU 120 to external circuitry by a USB connector (not illustrated). In some examples, the USB port 160 supplies power to the external circuitry. In other examples, the USB port 160 supplies power to the external circuitry and allows the communication circuitry 150 to communicate with the external circuitry.

FIG. 2 is a block diagram of an example vehicle 200. In the example of FIG. 2, the vehicle 200 includes a power source 210, an USB electronic control unit (ECU) 220, converter circuitry 230, regulator circuitry 240, communication circuitry 250, and a USB port 260. Alternatively, the vehicle 200 may include a plurality of ECUs that perform different operations. In some examples, the vehicle 200 includes safety ECUs to supply power from the power source 210 to safety features.

The power source 210 is coupled to the USB ECU 220 and may be coupled to other ECUs. The power source 210 provides a supply voltage to the converter circuitry 230 and the regulator circuitry 240. In some examples, the power source 210 is an energy storage device, such as a battery. In such examples, the supply voltage decreases as the energy storage device discharges. In one example, when the power source 210 is fully charged, the supply voltage is approximately twelve and a half volts (V). However, when the power source 210 is almost fully discharged, the supply voltage is approximately equal to eleven and a half volts. In another example, when the power source 210 is fully charged, the supply voltage is approximately five and a half volts (V). However, when the power source 210 is approximately fully discharged, the supply voltage is approximately equal to one and four-tenths volts. In such examples, the converter circuitry 230 and the regulator circuitry 240 account for variations in the supply voltage as the power source 210 discharges.

The USB ECU 220 has an input terminal coupled to the power source 210, a first output terminal coupled to the USB port 260, and a second output terminal coupled to the USB port 260. In the example of FIG. 2, the USB ECU 220 includes the converter circuitry 230, the regulator circuitry 240, and the communication circuitry 250. The USB ECU 220 receives the supply voltage (V_{SUP}) from the power source 210. The USB ECU 220 generates an output voltage (V_{OUT}) responsive to the supply voltage. The USB ECU 220 supplies the output voltage to the USB port 260. In some examples, the USB ECU 220 supplies power to external circuitry coupled to the USB port 260 responsive to supplying the output voltage to the USB port 260. The USB ECU 220 implements USB communication protocols to communicate with external circuitry coupled to the USB port 260. In some examples, the USB ECU 220 is coupled to one or more other ECUs (not pictured in FIG. 2) to support operations responsive to communications with the external circuitry.

The converter circuitry 230 has an input terminal coupled to the power source 210 and the regulator circuitry 240 and an output terminal coupled to the USB port 260. The converter circuitry 230 receives the supply voltage from the power source 210 as an input voltage (V_{IN}). The converter circuitry 230 generates an output voltage (V_{OUT}) responsive to the input voltage. In some examples, the converter circuitry 230 generates an output voltage that is less than the input voltage. In such examples, the converter circuitry 230 is referred to as buck converter circuitry. In other examples, the converter circuitry 230 generates the output voltage that is greater than the input voltage. In such examples, the converter circuitry 230 is referred to as boost converter circuitry. In yet another example, the converter circuitry 230 may generate an output voltage that is greater than or less than the input voltage. In such examples, the converter circuitry 230 is referred to as buck-boost converter circuitry.

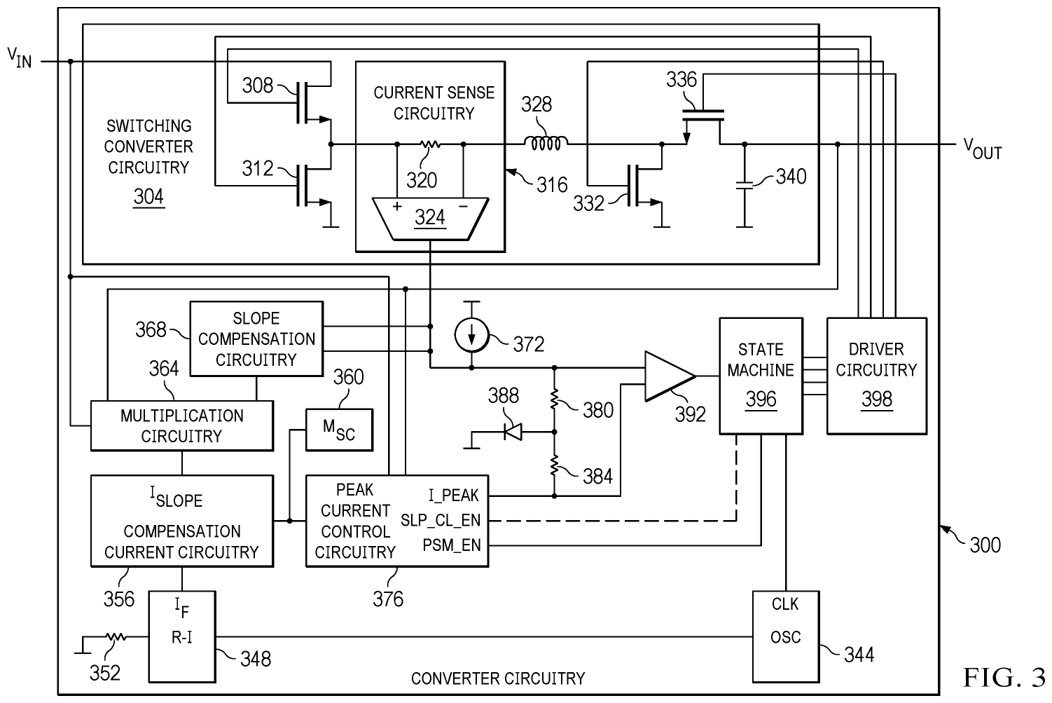

In example operations, the converter circuitry 230 utilizes switching to control current through an inductance. During some example operations, the converter circuitry 230 charges the inductance responsive to coupling the inductance to the input voltage, which generates a current in a first direction. During other example operations, the converter circuitry 230 allows the inductance to discharge responsive to coupling the inductance to a common potential, which generates a current in a second direction. In such example operations, switching the supply of current through the inductance using switches allows the converter circuitry 230 to generate the output voltage. In some examples, such as in FIG. 3, below, the converter circuitry 230 includes current sense circuitry 316 to accurately sense the current flowing through the inductance.

To control the charging and discharging of the inductance efficiently, the converter circuitry 230 dynamically adjusts a PSM entry value responsive to the input voltage and the output voltage of the converter circuitry 230 and a slope constant, which represents the switching frequency and the inductance. Advantageously, dynamically adjusting the PSM entry current allows the converter circuitry 230 to operate efficiently across a wide range of operating conditions. For example, when the converter circuitry 230 has a relatively large inductance, a relatively low switching frequency, and a relatively large current limit, the converter circuitry 230 lowers the PSM entry current to account for such conditions. In another example, when the converter circuitry 230 has a relatively small inductance, a relatively high switching frequency, and a relatively low current limit, the converter circuitry 230 increases the PSM entry current to account for such conditions.

In example operations where the power source 210 is an energy storage unit, such as FIG. 2, the converter circuitry 230 accounts for variations in the voltage of the power source 210 by adjusting the PSM entry current. Such an adjustment of the PSM entry current modifies the switching of current through the inductance to account for variations. Advantageously, the converter circuitry 230 adjusts the PSM entry current responsive to changes in the input voltage or the output voltage during operation. An example of the converter circuitry 230 is illustrated and described in connection with FIG. 3, below.

The regulator circuitry 240 has an input terminal coupled to the power source 210 and the converter circuitry 230 and an output terminal coupled to the communication circuitry 250. The regulator circuitry 240 receives the supply voltage from the power source 210. The regulator circuitry 240 regulates a supply of power from the power source 210 to supply an output voltage (V_{OUT}) to the communication circuitry 250. In some examples, the regulator circuitry 240 uses feedback loops to regulate the output voltage. For example, the regulator circuitry 240 may be linear regulator circuitry, which utilizes an error amplifier, a transistor, and resistor ladder to generate the output voltage. In such examples, the error amplifier regulates the current trough the transistor responsive to feedback from the resistor ladder. The regulator circuitry 240 supplies the output voltage to the communication circuitry 250.

The communication circuitry 250 has a first terminal coupled to the regulator circuitry 240, a second terminal coupled to the USB port 260, and a third terminal that may be coupled to external circuitry, which interfaces with the USB port 260 by the communication circuitry 250. The communication circuitry 250 receives the output voltage from the regulator circuitry 240 as a supply voltage. The communication circuitry 250 implements USB communication protocols to allow external circuitry, coupled to the USB port 260, to communicate with the vehicle 200. In some examples, the communication circuitry 250 is coupled to other ECUs to allow the external circuitry to interface with one or more operations of the vehicle 200. For example, the communication circuitry 250 facilitates communications between external circuitry and an audio ECU to play audio from the external circuitry.

The USB port 260 has a first terminal coupled to the converter circuitry 230 and a second terminal coupled to the communication circuitry 250. The USB port 260 couples the USB ECU 220 to external circuitry by a USB connector (not illustrated). In some examples, the USB port 260 supplies power to the external circuitry. In other examples, the USB port 260 supplies power to the external circuitry and allows the communication circuitry 250 to communicate with the external circuitry.

FIG. 3 is a schematic diagram of example converter circuitry 300, which is an example of the converter circuitry 230 of FIG. 2. In the example of FIG. 3, the converter circuitry 300 includes switching converter circuitry 304, oscillator circuitry 344, current generation circuitry 348, a second resistor 352, compensation current circuitry 356, slope constant circuitry 360, multiplication circuitry 364, slope compensation circuitry 368, current source circuitry 372, peak current control circuitry 376, a third resistor 380, a fourth resistor 384, a diode 388, a comparator 392, state machine circuitry 396, and driver circuitry 398. The switching converter circuitry includes a first transistor 308, a second transistor 312, current sense circuitry 316, an inductor 328, a third transistor 332, a fourth transistor 336, and a capacitor 340. The current sense circuitry 316 includes a first resistor 320 and a current sense amplifier 324. The converter circuitry 300 receives an input voltage (V_{IN}) from the power source 210 of FIG. 2. The converter circuitry 300 controls current through the inductor 328 to generate an output voltage (V_{OUT}).

In some example operations, the converter circuitry 300 generates an output voltage that is greater than the input voltage, such operations may be referred to as boost operations. In other example operations, the converter circuitry 300 generates an output voltage that is less than the input voltage, such operations may be referred to as buck operations. The converter circuitry 300 compares the current through the inductor 328 to a PSM entry current to control switching operations. The converter circuitry 300 determines the PSM entry current responsive to the input voltage, the output voltage, a switching frequency (f_{SW}), an inductance (L), and a sense resistance (R_{SNS}). The converter circuitry 300 dynamically adjusts the PSM entry current responsive to variations in the input voltage and/or the output voltage. In some examples, the converter circuitry 300 dynamically adjusts the PSM entry current responsive to variations in the switching frequency, the inductance, and the sense resistance. Advantageously, adjusting the PSM entry current increases efficiency and reliability of the converter circuitry 300.

The switching converter circuitry 304 has an input terminal coupled to the multiplication circuitry 364, the peak current control circuitry 376, and an input terminal of the converter circuitry 300, which supplies the input voltage. The switching converter circuitry 304 has an output terminal coupled to the multiplication circuitry 364, the peak current control circuitry 376, and that may be coupled to external circuitry to supply the output voltage. In the example of FIG. 3, the switching converter circuitry 304 includes the transistors 308, 312, 332, 336, the current sense circuitry 316, the inductor 328, and the capacitor 340. The switching converter circuitry 304 has an input terminal coupled to the input terminal of the converter circuitry 300, which supplies the input voltage, and control inputs coupled to the driver circuitry 398. The switching converter circuitry 304 has a first output terminal coupled to the slope compensation circuitry 368, the current source circuitry 372, the resistor 380, and the comparator 392 and a second output, which supplies the output voltage, coupled to the output terminal of the converter circuitry 300.

The driver circuitry 398 controls the switching converter circuitry 304. The switching converter circuitry 304 switches between coupling the inductor 328 to the input voltage and to a common terminal, which supplies a common potential (e.g., ground). The switching converter circuitry 304 generates the output voltage responsive to charging and discharging the inductor 328. A comparison of the current through the inductor to a determined peak current controls the switching operations of the switching converter circuitry 304. In the example of FIG. 3, the transistors 308, 312, 332, 336 may be referred to as the switches of the switching converter circuitry 304.

The transistor 308 has a first current terminal coupled to the multiplication circuitry 364, the peak current control circuitry 376, and the input terminal of the converter circuitry 300, which supplies the input voltage. The transistor 308 has a second current terminal coupled to the transistor 312 and the current sense circuitry 316. The transistor 308 has a control terminal coupled to the driver circuitry 398. The driver circuitry 398 controls the transistor 308. When conducting (e.g., enabled), the transistor 308 couples the inductor 328 to the input voltage by the current sense circuitry 316. In such an operation, the transistor 308 allows the transistors 308, 332 to form a current path to charge the inductor 328. When non-conducting (e.g., disabled), the transistor 308 prevents the input voltage from being coupled to the inductor 328. In such an example operation, the transistor 308 allows the transistors 312, 336 to form a current path to discharge the inductor 328.

The transistor 312 has a first current terminal coupled to the transistor 308 and the current sense circuitry 316, a second current terminal coupled to a common terminal, which supplies the common potential, and a control terminal coupled to the driver circuitry 398. The driver circuitry 398 controls the transistor 312. When conducting, the transistor 312 couples the inductor 328 to the common potential by the current sense circuitry 316. In such an operation, the transistor 312 allows the transistors 312, 336 to form a current path that discharges the inductor 328. When non-conducting, the transistor 312 prevents the common potential from being coupled to the inductor 328. In such an operation, the transistor 312 allows the transistors 308, 332 to form a current path to charge the inductor 328.

The current sense circuitry 316 has a first terminal coupled to the transistors 308, 312, a second terminal coupled to the inductor 328, and a third terminal coupled to the slope compensation circuitry 368, the current source circuitry 372, the resistor 380, and the comparator 392. In the example of FIG. 3, the current sense circuitry 316 includes the resistor 320 and the current sense amplifier 324. The current sense circuitry 316 is coupled in-line with (e.g., in the current path between) the transistors 308, 312 and the inductor 328. The current sense circuitry 316 generates a sense voltage proportional to the current flowing through the inductor 328. The current sense circuitry 316 supplies the sense voltage to the slope compensation circuitry 368, the resistor 380, and the comparator 392.

The resistor 320 has a first terminal coupled to the transistors 308, 312 and the current sense amplifier 324 and a second terminal coupled to the current sense amplifier 324 and the inductor 328. The resistor 320 is a sense resistor, which has a resistance referred to as a sense resistance (R_{SNS}). The resistor 320 generates a voltage difference approximately equal to the current through the inductor (I_{L}) times the sense resistance. In some examples, the resistor 320 has a relatively small resistance to reduce power consumption.

The current sense amplifier 324 has a first input terminal coupled to the transistors 308, 312 and the resistor 320 and a second input terminal coupled to the resistor 320 and the inductor 328. The current sense amplifier 324 has an output terminal coupled to the slope compensation circuitry 368, the current source circuitry 372, the resistor 380, and the comparator 392. The current sense amplifier 324 determines the voltage difference across the resistor 320. Advantageously, the voltage difference across the resistor 320 is proportional to the current through the inductor 328. The current sense amplifier 324 generates the sense voltage by supplying a sense current to the resistor 380. In example operations, the sense current is proportional to the voltage difference across the resistor 320. In some examples, the current sense amplifier 324 has a transconductance (gm_{SNS}). The transconductance of the current sense amplifier 324 sets gain of the sense current at the output of the current sense amplifier 324 proportional to the sense voltage. In such examples, the current sense amplifier 324 generates a sense output that reflects the current through the inductor 328 proportional to the transconductance of the current sense amplifier 324. The current sense amplifier 324 supplies the sense output to the slope compensation circuitry 368, the resistor 380, and the comparator 392. Advantageously, the current sense amplifier 324 generates an isolated representation of the current through the inductor 328.

The inductor 328 has a first terminal coupled to the current sense circuitry 316 and a second terminal coupled to the transistors 332, 336. The inductor 328 stores charge in the form of a magnetic field responsive to a current. The inductor 328 discharges the magnetic field by supplying a current using the charge of the magnetic field. In example operations, the inductor 328 charges responsive to the transistors 308, 332 forming a current path from the input terminal of the converter circuitry 300 to the common terminal. In such example operations, the inductor 328 discharges responsive to the transistors 312, 336 forming a current path from the common terminal to the output terminal of the converter circuitry 300. Such charging and discharging of the inductor 328 may generate an output voltage that may be greater than or less than the input voltage. The peak current control circuitry 376, the comparator 392, and the state machine circuitry 396 sequence charging and discharging intervals responsive to a determined peak current value. Advantageously, controlling the current through the inductor 328 controls the output voltage of the converter circuitry 300.

The transistor 332 has a first current terminal coupled to the inductor 328 and the transistor 336, a second current terminal coupled to the common terminal, which supplies the common potential, and a control terminal coupled to the driver circuitry 398. The driver circuitry 398 controls the transistor 332. When conducting, the transistor 332 couples the inductor 328 to the common terminal. In such example operations, the transistors 308, 332 may form a current path that charges the inductor 328. When non-conducting, the transistor 332 prevents the inductor 328 from being coupled to the common terminal. In such example operations, the transistor 332 allows the transistors 312, 336 to form a current path to discharge the inductor 328.

The transistor 336 has a first current terminal coupled to the inductor 328 and the transistor 332, a second current terminal coupled to the capacitor 340, the multiplication circuitry 364, and the peak current control circuitry 376, and a control terminal coupled to the driver circuitry 398. The driver circuitry 398 controls the transistor 336. When conducting, the transistor 336 couples the inductor 328 to the capacitor 340 and the output terminal of the converter circuitry 300. In such example operations, the transistors 312, 336 may form a current path that discharges the inductor 328 and generates the output voltage. When non-conducting, the transistor 336 prevents the inductor 328 from being coupled to the capacitor 340 and the output terminal. In such example operations, the transistor 336 allows the transistors 308, 332 to form a current path to charge the inductor 328.

The capacitor 340 has a first terminal coupled to the transistor 336, the multiplication circuitry 364, and the peak current control circuitry 376 and a second terminal coupled to the common terminal, which supplies the common potential. The capacitor 340 averages relatively high frequency changes in the output voltage responsive to storing (e.g., charging) or supplying (e.g., discharging) charges. The capacitor 340 filters relatively high frequency switching of the current supplied by the inductor 328 to generate a relatively stable direct current (DC) output voltage. In some examples, the capacitor 340 is external to the converter circuitry 300.

The oscillator circuitry 344 has an input terminal coupled to the current generation circuitry 348 and an output terminal coupled to the state machine circuitry 396. The oscillator circuitry 344 receives a frequency current from the current generation circuitry 348. The oscillator circuitry 344 generates a clock signal (CLK) of a predetermined frequency based on a magnitude of the frequency current from the current generation circuitry 348. The frequency current is a DC current that has a magnitude proportional to the frequency of the clock signal. The oscillator circuitry 344 supplies the clock signal to the state machine circuitry 396. The oscillator circuitry 344 may be a resistor-capacitor (RC) oscillator, an external crystal oscillator, etc. The oscillator circuitry 344 supplies the clock signal to the state machine circuitry 396.

The current generation circuitry 348 has a first terminal coupled to the oscillator circuitry 344, a second terminal coupled to the resistor 352, and a third terminal coupled to the compensation current circuitry 356. The current generation circuitry 348 controls the frequency of the clock signal by generating the frequency current (If) using the resistance of the resistor 352. In some examples, the current generation circuitry 348 generates the frequency current to be approximately a reference value of amps per megahertz (MHz) of the frequency of the clock signal. For example, when the reference value is sixteen microamps and the clock signal has a frequency of four megahertz, the current generation circuitry 348 generates the frequency current to be approximately thirty-two microamps. The current generation circuitry 348 supplies the frequency current to the oscillator circuitry 344 and the compensation current circuitry 356.

The resistor 352 has a first terminal coupled to the current generation circuitry 348 and a second terminal coupled to the common terminal, which supplies the common potential. The resistor 352 has a resistance configurable to set the reference value of the frequency current determined by the current generation circuitry 348. For example, adjusting the resistance of the resistor 352 modifies the scale of the frequency current.

The compensation current circuitry 356 has a first terminal coupled to the current generation circuitry 348, a second terminal coupled to the slope constant circuitry 360 and the peak current control circuitry 376, and a third terminal coupled to the multiplication circuitry 364. The compensation current circuitry 356 receives the frequency current from the current generation circuitry 348 and a slope constant (m_{sc}) from the slope constant circuitry 360. The slope constant is a correction value that is approximately equal to the sense resistance of the resistor 320 divided by a multiplication of the switching frequency of the converter circuitry 300 and the inductance of the inductor 328. The slope constant circuitry 360 may determine the slope constant using Equation (1), below.

$${m}_{sc} ∝ \frac{{R}_{SNS}}{{f}_{s} * L} ; \qquad Equation ( 1 )$$

The compensation current circuitry 356 generates a slope current (I_{Slope}) responsive to correcting the frequency current for the slope constant. The slope current is proportional to the frequency current times the slope constant. The slope current may be determined using Equation (2), below. The compensation current circuitry 356 supplies the slope current to the multiplication circuitry 364.

$${I}_{Slope} ∝ \frac{{R}_{SNS}}{L} ∝ {I}_{f} * {m}_{sc} ; \qquad Equation ( 2 )$$

The slope constant circuitry 360 has a terminal coupled to the compensation current circuitry 356 and the peak current control circuitry 376. The slope constant circuitry 360 determines the slope constant using Equation (1), above. In some examples, the slope constant circuitry 360 includes configurable register circuitry to allow designers to specify values of the switching frequency of the converter circuitry 300, the inductance of the inductor 328, and/or the sense resistance of the resistor 320. In such examples, the slope constant circuitry 360 determines the slope constant responsive to the values of the register circuitry. In other examples, the slope constant circuitry 360 may be coupled to circuitry that identifies one of the switching frequency of the converter circuitry 300, the inductance of the inductor 328, and/or the sense resistance of the resistor 320. For example, the slope constant circuitry 360 may receive a value of the switching frequency from the state machine circuitry 396. The slope constant circuitry 360 supplies the slope constant to the compensation current circuitry 356 and the peak current control circuitry 376.

The multiplication circuitry 364 has a first input terminal coupled to the switching converter circuitry 304 the peak current control circuitry 376, and the input terminal of the converter circuitry 300, which supplies the input voltage. The multiplication circuitry 364 has a second input terminal coupled to the switching converter circuitry 304, the peak current control circuitry 376, and the output terminal of the converter circuitry 300, which supplies the output voltage. The multiplication circuitry 364 has a third input terminal coupled to the compensation current circuitry 356 and an output terminal coupled to the slope compensation circuitry 368. The multiplication circuitry 364 receives the input voltage and the output voltage of the converter circuitry 300 and the slope current from the compensation current circuitry 356.

When the converter circuitry 300 is in a boost mode (e.g., the input voltage is less than the output voltage), the multiplication circuitry 364 generates a slope compensation current (I_{SCC}) approximately equal to the slope current times the difference between the output voltage and the input voltage of the converter circuitry 300. The multiplication circuitry 364 may use Equation (3), below, to determine the slope compensation current, when the converter circuitry is in boost mode.

$${I}_{SCC} ( Boost ) ∝ {I}_{Slope} * ( {V}_{OUT} - {V}_{IN} ) ; \qquad Equation ( 3 )$$

When the converter circuitry 300 is in buck mode (e.g., the input voltage is greater than the output voltage) or is capable of being in either buck-boost modes (e.g., the input voltage may be greater than or less than the output voltage), the multiplication circuitry 364 generates a slope compensation current (I_{SCC}) approximately equal to the slope current times the output voltage of the converter circuitry 300. The multiplication circuitry 364 may use Equation (4), below, to determine the slope compensation current, when the converter circuitry is a Buck converter or a Buck-Boost converter. The multiplication circuitry 364 supplies the slope compensation current to the slope compensation circuitry 368.

$${I}_{SCC} ( Buck / Buck - Boost ) ∝ {I}_{Slope} * {V}_{OUT} ; \qquad Equation ( 4 )$$

The slope compensation circuitry 368 has an input terminal coupled to the multiplication circuitry 364. The slope compensation circuitry 368 has a first and second output terminal coupled to the current sense circuitry 316, the current sense amplifier 324, the current source circuitry 372, the resistor 380, and the comparator 392. The slope compensation circuitry 368 receives the slope compensation current from the multiplication circuitry 364. The slope compensation circuitry 368 generates a ramp signal having a slope proportional to the slope compensation current. In example operations, the slope of the ramp signal increases responsive to increasing the output voltage and/or decreasing the inductance of the inductor 328. The compensation current circuitry 356 and/or the multiplication circuitry 364 adjust the slope current and/or the slope compensation current responsive to such changes.

The slope compensation circuitry 368 supplies the ramp signal to the resistor 380 and the comparator 392 to combine the ramp signal with the sense voltage from the current sense amplifier 324. Advantageously, combining the ramp signal and the sense voltage increases the range of currents through the inductor 328 that may be compared by the comparator 392. However, the ramp signal offsets the sense voltage from the current sense amplifier 324. The slope compensation circuitry 368 sinks, at the second output terminal, the slope compensation current from the combined sense voltage and ramp signal. Advantageously, the slope compensation circuitry 368 reduces the DC offset resulting from combining the sense voltage and the ramp signal by sinking the slope compensation current from the combined signals. Advantageously, the slope compensation circuitry 368 increases the range of the current through the inductor 328 that may be compared by the comparator 392 by compensating the sense voltage for the output voltage of the converter circuitry 300, the sense resistance of the resistor 320, and the inductance of the inductor 328. Advantageously, the slope compensation circuitry 368 compensates for a slope and ramp of the sense voltage. Advantageously, the slope compensation circuitry 368 increases stability and decreases harmonic oscillations.

The current source circuitry 372 has a first terminal coupled to a supply terminal, which supplies a supply voltage, and a second terminal coupled to the switching converter circuitry 304, the slope compensation circuitry 368, the resistor 380, and the comparator 392. The current source circuitry 372 supplies a reference current to the resistor 380 and the comparator 392. The reference current allows the offset combination of the sense voltage and the ramp signal to have negative currents. Advantageously, the current source circuitry 372 allows the current sense amplifier 324 and the slope compensation circuitry to represent negative currents through the inductor 328 at the comparator 392.

The peak current control circuitry 376 has a first input terminal coupled to the switching converter circuitry 304, the multiplication circuitry 364, and the input terminal of the converter circuitry 300, which supplies the input voltage. The peak current control circuitry 376 has a second input terminal coupled to the switching converter circuitry 304, the transistor 336, the capacitor 340, the multiplication circuitry 364, and the output terminal of the converter circuitry 300, which supplies the output voltage. The peak current control circuitry 376 has a third input terminal coupled to the compensation current circuitry 356 and the slope constant circuitry 360. The peak current control circuitry 376 has a first output terminal coupled to the resistor 384 and the comparator 392, a second output terminal coupled to the state machine circuitry 396 and may have a third output terminal coupled to the state machine circuitry 396. The peak current control circuitry 376 receives the input and output voltages of the converter circuitry 300 and the slope constant from the slope constant circuitry 360.

The peak current control circuitry 376 generates a peak current and a PSM entry value responsive to the input and output voltages of the converter circuitry 300 and the slope constant. The peak current represents a maximum current through the inductor 328, such as a current limit. The PSM entry value represents a fraction of the maximum current, which is close to boundary conduction of the inductor 328. A ripple current of the inductor 328 defines a location of the boundary conduction of the inductor 328.

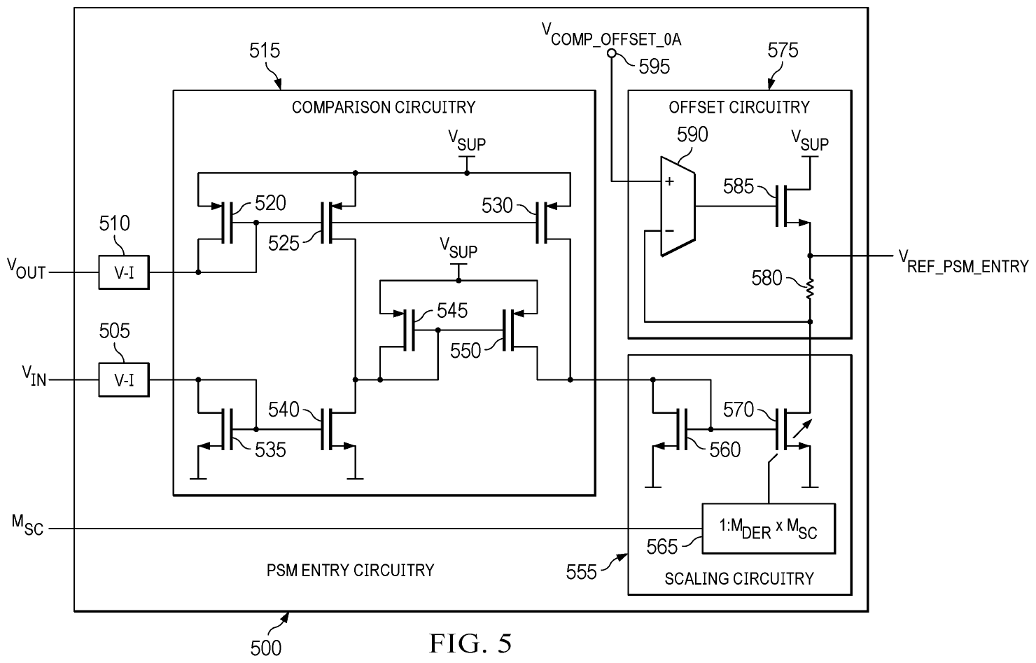

In example boost mode of operations, the boost ripple current (I_{rbo}) of the inductor 328 is based on the input and output voltages (V_{IN}, V_{OUT}) of the converter circuitry 300, the switching frequency (fₛ) of the converter circuitry 300, and the inductance (L) of the inductor 328, as shown below in Equation (5). An example of the boost ripple current of the inductor 328 is illustrated and described in FIG. 5, below.

$${I}_{rbo} = \frac{{V}_{IN}}{{V}_{OUT}} \cdot ( {V}_{OUT} - {V}_{IN} ) \cdot \frac{1}{{f}_{s} \cdot L} ; \qquad Equation ( 5 )$$

In such example boost mode operations, the boundary condition of the inductor 328 occurs at a maximum inductor ripple current (I_{rbomax}). In some examples, limitations of components of the converter circuitry 300 determine the maximum inductor ripple current. For example, the maximum inductor ripple current may be set to a maximum current of the transistor 308. The maximum inductor ripple current occurs when the output voltage of the converter circuitry 300 is approximately two times the input voltage (e.g., V_{OUT} is set equal to 2V_{IN}) of the converter circuitry 300. In example boost mode of operations, the maximum inductor ripple current of the inductor 328 is based on the output voltage (V_{OUT}) of the converter circuitry 300, the switching frequency (fₛ) of the converter circuitry 300, and the inductance (L) of the inductor 328, as shown below in Equation (6).

$${I}_{rbomax} = \frac{{V}_{OUT}}{4} \cdot \frac{1}{{f}_{s} \cdot L} ; \qquad Equation ( 6 )$$

Using Equation (1), above, the maximum inductor ripple current of the inductor 328 may be further reduced in terms of the slope constant (m_{sc}). In example Boost mode operations, a buck PSM entry inductor current (I_{PSMbo}) is based on the output voltage (V_{OUT}) of the converter circuitry 300, the slope constant of the slope constant circuitry 360, and the sense resistance (R_{SNS}) of the resistor 320, as shown below in Equation (7).

$${I}_{PSMbo} ∝ \frac{{V}_{OUT} \cdot {m}_{sc}}{{R}_{SNS}} ; \qquad Equation ( 7 )$$

Advantageously, as described above, the sense resistance of the resistor 320 is proportional to the current through the inductor 328. In the example operations of PSM entry, the current through the inductor is approximately equal to a current limit (I_{CL}) of the inductor 328. Accordingly, in the example operations, the sense resistance is proportional to the current limit, as shown below in Equation (8).

$${R}_{SNS} ∝ \frac{1}{{I}_{CL}} ; \qquad Equation ( 8 )$$

Using Equation (8), above, the boost mode PSM entry inductor current of the inductor 328 may be further reduced in terms of the current limit. In example boost mode operations, the PSM entry inductor current is based on the output voltage (V_{OUT}) of the converter circuitry 300, the slope constant (m_{sc}) of the slope constant circuitry 360, and the current limit (I_{CL}) of the inductor 328, as shown below in Equation (9).

$${I}_{PSMbo} ∝ {V}_{OUT} \cdot {m}_{sc} \cdot {I}_{CL} ; \qquad Equation ( 9 )$$

In some examples, the peak current control circuitry 376 generates the PSM entry value as a boost PSM entry voltage (V_{PSMbo}). In such examples, when in the boost mode of operations, the PSM entry voltage is based on the PSM entry inductor current times the sense resistance (R_{SNS}) of the resistor 320, the transconductance (gm_{SNS}) of the current sense amplifier 324, and a resistance (R_{PEAK}) of the resistors 380, 384, as shown below in Equation (10).

$${V}_{PSMbo} ∝ {V}_{OUT} \cdot {m}_{sc} \cdot {gm}_{SNS} \cdot {R}_{Peak} \cdot {R}_{SNS} \cdot {I}_{CL} ; \qquad Equation ( 10 )$$

Advantageously, the PSM entry voltage may be further reduced responsive to the sense resistance of the resistor 320, the transconductance of the current sense amplifier 324, the resistance of the resistors 380, 384, and the current limit are fixed values. Accordingly, the PSM entry voltage is proportional to the variations in the output voltage and the slope constant of the converter circuitry 300, as shown below in Equation (11).

$${V}_{PSMbo} ∝ {V}_{OUT} \cdot {m}_{sc} ; \qquad Equation ( 11 )$$

In example buck mode of operations, the buck ripple current (I_{rbu}) of the inductor 328 is based on the input and output voltages (V_{IN}, V_{OUT}) of the converter circuitry 300, the switching frequency (fₛ) of the converter circuitry 300, and the inductance (L) of the inductor 328, as shown below in Equation (12). An example of the buck ripple current of the inductor 328 is illustrated and described in FIG. 5, below.

$${I}_{rbu} = \frac{{V}_{OUT}}{{V}_{IN}} \cdot ( {V}_{IN} - {V}_{OUT} ) \cdot \frac{1}{{f}_{s} \cdot L} ; \qquad Equation ( 12 )$$

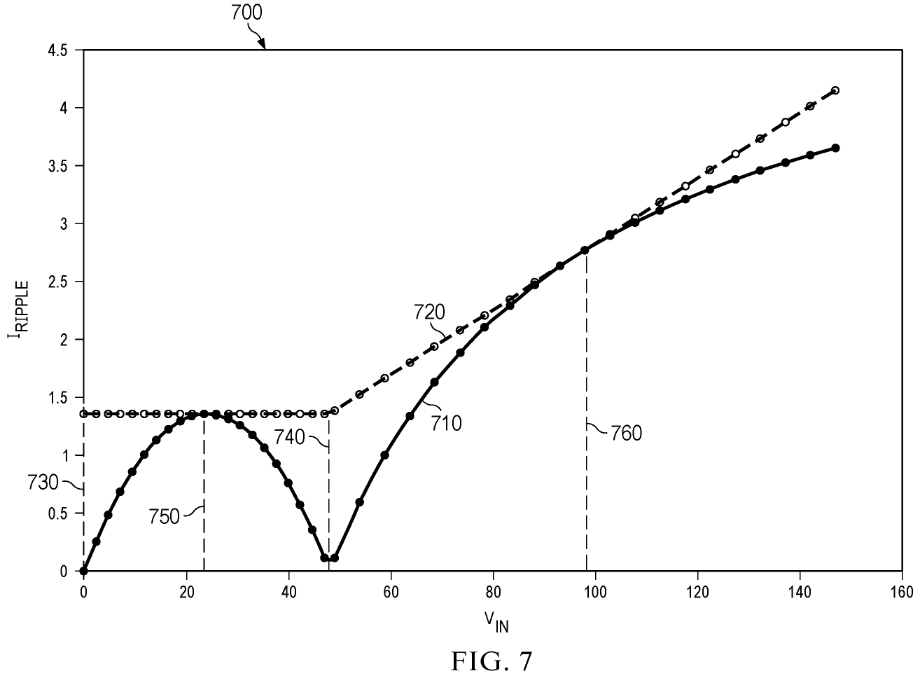

In such example buck mode operations, the boundary condition of the inductor 328 occurs at a linearized buck inductor ripple current (I_{rbulin}) that linearizes the PSM entry values across buck and boost modes of operations. Selecting the buck inductor ripple current that occurs when the input voltage of the converter circuitry 300 is approximately two times the output voltage (e.g., V_{IN} is set equal to 2V_{OUT}) of the converter circuitry 300 linearizes the PSM entry values for buck modes of operations. Such an example buck inductor ripple current is illustrated and described in connection with FIG. 7, below. In example buck mode of operations, the maximum buck inductor ripple current of the inductor 328 is based on the input voltage (V_{IN}) of the converter circuitry 300, the switching frequency (fₛ) of the converter circuitry 300, and the inductance (L) of the inductor 328, as shown below in Equation (13).

$${I}_{rbulin} = \frac{{V}_{IN}}{4} \cdot \frac{1}{{f}_{s} \cdot L} ; \qquad Equation ( 13 )$$

Using Equation (1), above, the maximum buck inductor ripple current of the inductor 328 may be further reduced in terms of the slope constant (m_{sc}). In example buck mode operations, an PSM entry inductor current (I_{PSMbu}) is based on the input voltage (V_{IN}) of the converter circuitry 300, the slope constant of the slope constant circuitry 360, and the sense resistance (R_{SNS}) of the resistor 320, as shown below in Equation (14).

$${I}_{PSMbu} ∝ \frac{{V}_{IN} \cdot {m}_{sc}}{{R}_{SNS}} ; \qquad Equation ( 14 )$$

Using Equation (8), above, the buck PSM entry inductor current of the inductor 328 may be further reduced in terms of the current limit. In example Boost mode operations, the Buck PSM entry inductor current is based on the input voltage (V_{IN}) of the converter circuitry 300, the slope constant (m_{sc}) of the slope constant circuitry 360, and the current limit (I_{CL}) of the inductor 328, as shown below in Equation (15).

$${I}_{PSMbu} ∝ {V}_{IN} \cdot {m}_{sc} \cdot {I}_{CL} ; \qquad Equation ( 15 )$$

Advantageously, the buck PSM entry voltage may be further reduced responsive to the sense resistance of the resistor 320, the transconductance of the current sense amplifier 324, the resistance of the resistors 380, 384, and the current limit are fixed values. Accordingly, the buck PSM entry voltage is proportional to the variations in the input voltage and the slope constant of the converter circuitry 300, as shown below in Equation (16).

$${V}_{PSMbu} ∝ {V}_{IN} \cdot {m}_{sc} ; \qquad Equation ( 16 )$$

When the PSM entry value is reached, the converter circuitry 300 reduces the switching frequency to begin operating in a power saving mode. In the power saving mode, the state machine circuitry 396 optimizes the switching frequency of the transistors 308, 312, 332, 336 to optimize efficiency and performance.

In example operations, the peak current control circuitry 376 generates the PSM entry value responsive to the input and output voltages of the converter circuitry 300, the slope constant from the slope constant circuitry 360, and the determined peak current. Advantageously, the peak current control circuitry 376 adaptively adjusts the PSM entry value responsive to changes in the input and/or output voltages of the converter circuitry 300, the slope constant from the slope constant circuitry 360, and the determined peak current. Advantageously, dynamically adjusting the PSM entry value during operation increases power efficiency of the converter circuitry 300. The peak current control circuitry 376 supplies the peak current to the resistor 384 and the comparator 392 and the PSM entry value to the state machine circuitry 396.

In some examples, the peak current control circuitry 376 generates a sleep clamp value responsive to determining the peak current and the PSM entry value. The sleep clamp value represents another boundary condition, which is checked for once the converter circuitry 300 has entered PSM. The sleep clamp value is a fraction of the maximum current through the inductor 328, which is less than the PSM entry value. The state machine circuitry 396 checks the sleep clamp value responsive to entering power saving mode. When the sleep clamp value is reached, the converter circuitry 300 increases the switching frequency to begin operating in a normal mode of operation (e.g., leaving PSM). Advantageously, the sleep clamp value allows the switching frequency of the converter circuitry 300 to remain in proximity to the conditions of power saving mode. Advantageously, such control of the switching frequency increases power efficiency. The peak current control circuitry 376 supplies the sleep clamp value to the state machine circuitry 396.

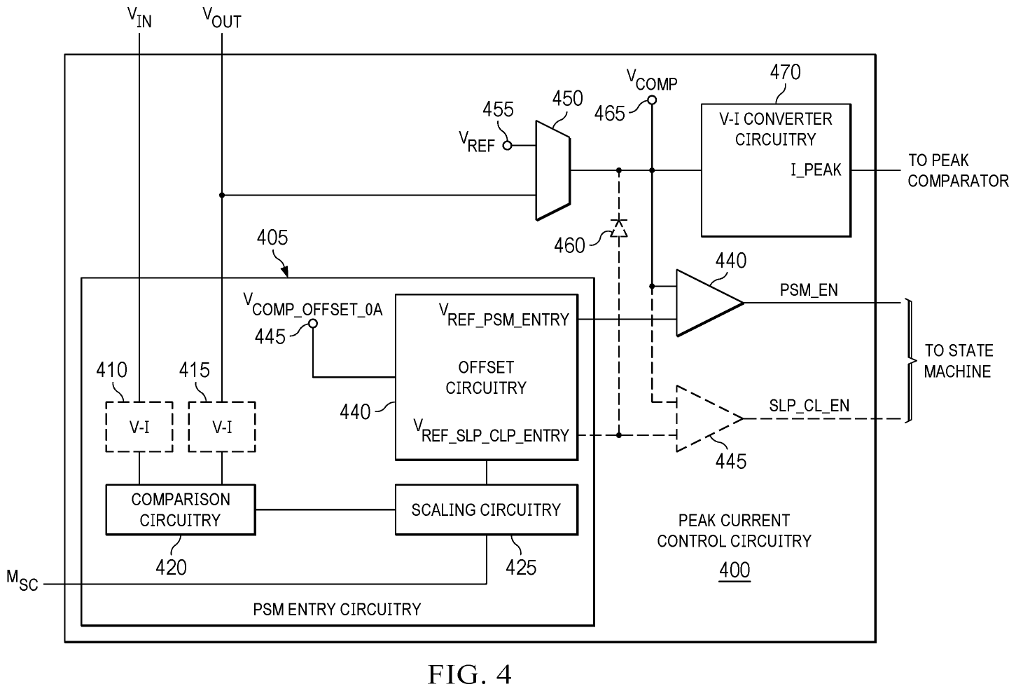

An example of the peak current control circuitry 376 is illustrated and described in connection with FIG. 4, below. Example circuitry to determine the peak current is illustrated and described in connection with FIG. 3. Example circuitry to determine the PSM entry value is illustrated and described in connection with FIGS. 4, 5, and 6. Example circuitry to determine the sleep clamp value is illustrated and described in connection with FIGS. 3 and 5.

The resistor 380 has a first terminal coupled to the switching converter circuitry 304, the slope compensation circuitry 368, the current source circuitry 372, and the comparator 392 and a second terminal coupled to the resistor 384 and the diode 388. The resistor 384 has a first terminal coupled to the resistor 380 and the diode 388 and a second terminal coupled to the peak current control circuitry 376 and the comparator 392. The diode 388 has a first terminal coupled to the resistors 380, 384 and a second terminal coupled to the common terminal, which supplies the common potential. The resistors 380, 384 form a voltage divider. The resistors 380, 384 and the diode 388 provide a current path for currents at the inputs of the comparator 392 to the common terminal. Such a current path ensures that the inputs of the comparator 392 are set in relation to the common potential. In some examples, the resistors 380, 384 are summing resistors, which combine current contributions from one or more circuits. For example, the resistor 380 combines the current contributions from the current sense amplifier 324, the slope compensation circuitry 368, and the current source circuitry 372. The resistor 380 generates a first reference voltage proportional to the resistance of the resistor 380 and the combined currents at the first terminal. The resistor 384 generates a second reference voltage proportional to the resistance of the resistor 384 and the combined currents at the first terminal.

The comparator 392 has a first input terminal coupled to the switching converter circuitry 304, the slope compensation circuitry 368, the current source circuitry 372, and the resistor 380 and a second input terminal coupled to the peak current control circuitry 376 and the resistor 384. The comparator 392 has an output terminal coupled to the state machine circuitry 396. The comparator 392 receives the first and second reference voltages from the resistors 380, 384. The comparator 392 compares the first and second reference voltages to generate a peak comparison output. The peak comparison output represents a comparison of the current through the inductor 328 to the peak current. Such a comparison results in the peak comparison output being a fractional representation of the current through the inductor 328 to the peak current. The comparator 392 supplies the peak comparison output to the state machine circuitry 396.

The state machine circuitry 396 has a first input terminal and a second input terminal coupled to the peak current control circuitry 376, a third input terminal coupled oscillator circuitry 344, and a fourth input terminal coupled to the comparator 392. The state machine circuitry 396 has a first output terminal, a second output terminal, a third output terminal, and a fourth output terminal coupled to the driver circuitry 398. The state machine circuitry 396 receives the clock signal from the oscillator circuitry 344, the peak comparison output from the comparator 392, the PSM entry value from the peak current control circuitry 376, and may receive the sleep clamp value from the peak current control circuitry 376. In some examples, the state machine circuitry 396 is referred to as a finite state machine (FSM). The state machine circuitry 396 determines the switching frequency of the converter circuitry 300 responsive to the peak comparison output, the PSM entry value, and/or the sleep clamp value. The state machine circuitry 396 generates control signals to control the transistors 308, 312, 332, 336.

In example operations, the state machine circuitry 396 generates the control signals responsive to a pulse width modulation (PWM) signal of an initial switching frequency. The duty cycle of the PWM signal corresponds to durations where the transistors 308, 312, 332, 336 are either charging or discharging the inductor 328. In such example operations, the state machine circuitry 396 begins monitoring the peak comparison output to prevent excessive current through the inductor 328. Also, the state machine circuitry 396 begins to compare the peak comparison output to the PSM entry value. When the state machine circuitry 396 detects that the peak comparison output is approximately equal to the PSM entry value, the state machine circuitry 396 enters a power saving mode. In some examples, the state machine circuitry 396 enters a power saving mode by decreasing the switching frequency of the PWM signal. In other examples, the state machine circuitry 396 enters a power saving mode by skipping one or more cycles switching. For example, the state machine circuitry 396 allows the inductor to discharge during the one or more cycles of switching. In both examples, the state machine circuitry 396 increases power efficiency by keeping the inductor 328 near a boundary conduction condition.

The state machine circuitry 396 generates the control signal to switch between formation of a first current path, using the transistors 308, 332 to charge the inductor 328, and a second current path, using the transistors 312, 336 to discharge the inductor 328. The state machine circuitry 396 supplies the control signals to the driver circuitry 398.

The driver circuitry 398 has a first input terminal, a second input terminal, a third input terminal, and a fourth input terminal coupled to the driver circuitry 398. The driver circuitry 398 has a first output terminal coupled to the transistor 308, a second output terminal coupled to the transistor 312, a third output terminal coupled to the transistor 332, and a fourth output terminal coupled to the transistor 336. The driver circuitry 398 receives the control signals from the state machine circuitry 396. The driver circuitry 398 converts the control signals from a power domain of the state machine circuitry 396 to a power domain of the switching converter circuitry 304. In some examples, the driver circuitry 398 ensures that the control signals are capable of fully saturating the transistors 308, 312, 332, 336. For example, the driver circuitry 398 increases the signal strength of the control signals to allow the state machine circuitry 396 to operate at a relatively low voltage compared to a relatively high voltage of the switching converter circuitry 304. The driver circuitry 398 supplies the control signals to the transistors 308, 312, 332, 336.

FIG. 4 is a schematic diagram of example peak current control circuitry 400, which is an example of the peak current control circuitry 376 of FIG. 3. In the example of FIG. 4, the peak current control circuitry 400 includes PSM entry circuitry 405, a first amplifier 440, a second amplifier 445, an error amplifier 450, a reference voltage 455, a diode 460, a compensation voltage 465, and third V-I converter circuitry 470. In the example of FIG. 4, the PSM entry circuitry 405 includes first voltage-to-current (V-I) converter circuitry 410, second V-I converter circuitry 415, comparison circuitry 420, scaling circuitry 425, offset circuitry 430, and a reference compensation voltage 435. The peak current control circuitry 400 is adapted to be coupled to an input terminal of converter circuitry (e.g., the converter circuitry 300 of FIG. 3), which supplies an input voltage (V_{IN}), and an output terminal of the converter circuitry, which supplies an output voltage (V_{OUT}). The peak current control circuitry 400 generates a peak current (I_PEAK), a PSM entry value (PSM_EN), and/or a sleep clamp value (SLP_CL_EN) responsive to receiving the input voltage, the output voltage, and a slope constant (m_{sc}) of the converter circuitry. The peak current control circuitry 400 dynamically adjusts the PSM entry value and the sleep clamp value responsive to changes in the input voltage, the output voltage, and/or the slope constant.

The PSM entry circuitry 405 has a first input terminal coupled to the input terminal of converter circuitry, which supplies the input voltage, a second input terminal coupled to the error amplifier 450 and the output terminal of the converter circuitry, which supplies the output voltage, and a third input terminal coupled to a slope constant terminal, which supplies the slope constant value. The PSM entry circuitry 405 has a first output terminal coupled to the amplifier 440 and may have a second output terminal coupled to the amplifier 445. The PSM entry circuitry 405 includes the V-I converter circuitry 410, 415, the comparison circuitry 420, the scaling circuitry 425, the offset circuitry 430, and the reference compensation voltage 435. The PSM entry circuitry 405 receives the input voltage, the output voltage, and the slope constant of converter circuitry. The PSM entry circuitry 405 dynamically determines the PSM entry value and/or the sleep clamp value responsive to the input voltage, the output voltage, and the slope constant of converter circuitry. The PSM entry circuitry 405 supplies the PSM entry value and/or the sleep clamp value to the amplifiers 440, 445.

The V-I converter circuitry 410 has an input terminal coupled to the input terminal of converter circuitry, which supplies the input voltage, and an output terminal coupled to the comparison circuitry 420. The V-I converter circuitry 410 receives the input voltage of the converter circuitry. The V-I converter circuitry 410 generates a first current proportional to the input voltage. In some examples, the V-I converter circuitry 410 includes a resistor divider, which generates the first current proportionally to the input voltage. The V-I converter circuitry 410 supplies the first current to the comparison circuitry 420.

The V-I converter circuitry 415 has an input terminal coupled to the error amplifier 450 and the output terminal of converter circuitry, which supplies the output voltage, and an output terminal coupled to the comparison circuitry 420. The V-I converter circuitry 415 receives the output voltage of the converter circuitry. The V-I converter circuitry 415 generates a second current proportional to the output voltage of the converter circuitry. The V-I converter circuitry 415 supplies the second current to the comparison circuitry 420. In the example of FIG. 4, the comparison circuitry 420 compares currents from the V-I converter circuitry 410, 415. Alternatively, with slight modifications to PSM entry circuitry 405, the comparison circuitry 420 may compare voltages. In such examples, the V-I converter circuitry 410, 415 may not be included (e.g., removing the dashed boxes) or modified to buffer input voltages of the comparison circuitry 420.

The comparison circuitry 420 has a first input terminal coupled to the V-I converter circuitry 410, a second input terminal coupled to the V-I converter circuitry 415, and an output terminal coupled to the scaling circuitry 425. The comparison circuitry 420 receives the first current from the V-I converter circuitry 410 and the second current from the V-I converter circuitry 415. The comparison circuitry 420 compares the first current to the second current. The comparison circuitry 420 generates a comparison output current responsive to the comparison of the first current to the second current. When the first current is greater than the second current, such as when the input voltage is greater than the output voltage, the comparison circuitry 420 sets the comparison output current proportional to the first current. When the second current is greater than the first current, such as when the input voltage is less than the output voltage, the comparison circuitry 420 sets the comparison output current proportional to the second current. The comparison circuitry 420 supplies the comparison output current to the scaling circuitry 425. Examples of the comparison circuitry 420 are illustrated and further described in connection with FIGS. 4 and 5, below.

The scaling circuitry 425 has a first input terminal coupled to the comparison circuitry 420, a second input terminal coupled to the slope constant terminal, which supplies the slope constant, and an output terminal coupled to the offset circuitry 430. The scaling circuitry 425 receives the comparison output current from the scaling circuitry 425 and the slope constant from slope constant circuitry (e.g., the slope constant circuitry 360 of FIG. 3). The scaling circuitry 425 generates a scaled current responsive to scaling the comparison output current by the slope constant. In example operations, the scaled current represents the PSM entry current. The scaled current represents the PSM entry currents generated by Equations (9) or (15), above. In some examples, the scaling circuitry 425 scales the comparison output current by the slope constant and a derating value. The derating value accounts for variations in the inductance of an inductor (e.g., the inductor 328 of FIG. 3) across a range of inductor currents. The scaling circuitry 425 sinks the scaled current from the offset circuitry 430. Examples of the scaling circuitry 425 are illustrated and further described in connection with FIGS. 4 and 5, below.

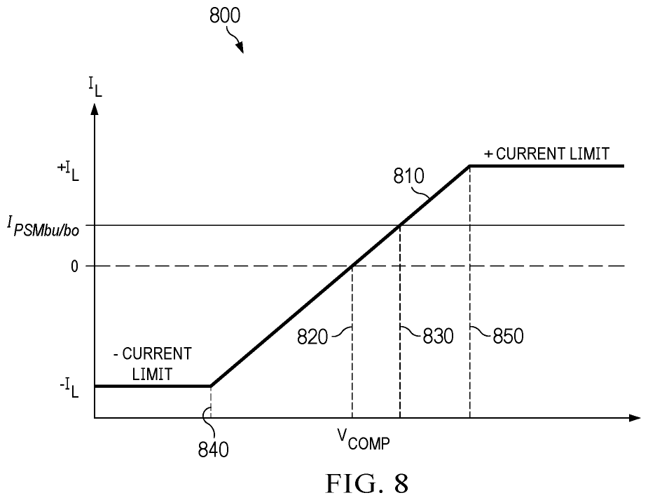

The offset circuitry 430 has a first input terminal coupled to the scaling circuitry 425, a second input terminal coupled to the reference compensation voltage 435, a first output terminal coupled to the amplifier 440, and may have a second output terminal coupled to the amplifier 445. The scaling circuitry 425 sinks the scaled current from the offset circuitry 330. The offset circuitry 430 receives the reference compensation voltage 435. The reference compensation voltage 435 represents a value of the compensation voltage 465 that corresponds to a zero current operation. Zero current operation occurs when the current through the inductor 328 is approximately zero. An example of the reference compensation voltage 435 is illustrated and further described in connection with FIG. 8, below. The offset circuitry 430 generates a reference PSM entry voltage by offsetting the reference compensation voltage 435 by the scaled current. The offset circuitry 430 determines the amount of offset responsive to the magnitude of the scaled current. In some examples, the offset circuitry 430 generates a reference sleep clamp voltage by offsetting the PSM entry value. The offset circuitry 430 supplies the reference PSM entry voltage and/or the reference sleep clamp voltage to the amplifiers 440, 445. Examples of the offset circuitry 430 are illustrated and further described in connection with FIGS. 4 and 5, below.

The amplifier 440 has a first input terminal coupled to the offset circuitry 430, a second input terminal coupled to the error amplifier 450, the compensation voltage 465, and the V-I converter circuitry 470, and an output terminal that may be coupled to the state machine circuitry 396 of FIG. 3. The amplifier 440 receives the reference PSM entry voltage from the offset circuitry 430 and the compensation voltage 465 from the error amplifier 450. The amplifier 440 generates the PSM entry value responsive comparing the reference PSM entry voltage to the compensation voltage 465. The amplifier 440 sets the PSM entry value as a fraction of the peak current. The amplifier 440 supplies the PSM entry value to the state machine circuitry 396.

The amplifier 445 has a first input terminal coupled to the offset circuitry 430 and the diode 460, a second input terminal coupled to the amplifier 440, the error amplifier 450, the diode 460, and the compensation voltage 465, the V-I converter circuitry 470, and an output terminal that may be coupled to the state machine circuitry 396. The amplifier 445 receives the reference sleep clamp voltage from the offset circuitry 430 and the compensation voltage 465 from the error amplifier 450. The amplifier 445 generates the sleep clamp value responsive to a comparison of the reference sleep clamp voltage to the compensation voltage 465. The amplifier 445 sets the sleep clamp value as a fraction of the peak current. The amplifier 445 supplies the sleep clamp value to the state machine circuitry 396. In the example of FIG. 4, the amplifier 445 generates the sleep clamp value. Alternatively, with slight modifications to PSM entry circuitry 405, the amplifier 445 may not be included (e.g., removing the dashed amplifier and traces).

The error amplifier 450 has an input terminal coupled to the V-I converter circuitry 415 and that may be coupled to the output terminal of converter circuitry, a second input terminal coupled to the reference voltage 455, and the output terminal coupled to the amplifiers 440, 445, the diode 460, the compensation voltage 465, and the V-I converter circuitry 470. The error amplifier 450 receives the output voltage from the converter circuitry and the reference voltage 455. The reference voltage 455 represents a target output voltage of the converter circuitry 300. In some examples, the reference voltage 455 is a scaled version of the target output voltage. For example, when the target output voltage of the converter circuitry 300 is relatively large, the reference voltage 455 may be scaled to be approximately one-fifth of the target output voltage.

The error amplifier 450 determines a voltage difference between the output voltage and the reference voltage 455. The error amplifier 450 generates the compensation voltage 465 proportional to the voltage difference between the output voltage and the reference voltage 455. In some examples, the error amplifier 450 has a gain to amplify the voltage difference to account for a scaling of the reference voltage. For example, the current sense amplifier 324 has a gain of one-tenth responsive to the reference voltage 455 being one-tenth of the target output voltage. The error amplifier 450 supplies the compensation voltage 465 to the amplifiers 440, 445 and the V-I converter circuitry 470.

The diode 460 has a first terminal coupled to the offset circuitry 430 and the amplifier 445 and a second terminal coupled to the amplifiers 440, 445, 450, the compensation voltage 465, and the V-I converter circuitry 470. The diode 460 sets the compensation voltage 465 approximately equal to the reference sleep clamp voltage responsive to the reference sleep clamp voltage being greater than the compensation voltage 465.

The V-I converter circuitry 470 has an input terminal coupled to the amplifiers 440, 445, 450, the diode 460, and the compensation voltage 465 and an output terminal that may be coupled to the comparator 392 of FIG. 3. The V-I converter circuitry 470 receives the compensation voltage 465 from the error amplifier 450. The V-I converter circuitry 470 generates the peak current responsive to converting the compensation voltage 465 to a current. The V-I converter circuitry 470 supplies the peak current to the resistor 384 and the comparator 392.

FIG. 5 is a schematic diagram of example PSM entry circuitry 500, which is an example of the PSM entry circuitry 405 of FIG. 4. In the example of FIG. 5, the PSM entry circuitry 500 includes first V-I converter circuitry 505, second V-I converter circuitry 510, comparison circuitry 515, scaling circuitry 555, offset circuitry 575, and an offset voltage 595. In the example of FIG. 5, the comparison circuitry 515 includes a first transistor 520, a second transistor 525, a third transistor 530, a fourth transistor 535, a fifth transistor 540, a sixth transistor 545, and a seventh transistor 550. In the example of FIG. 5, the scaling circuitry 555 includes an eighth transistor 560, trim circuitry 565, and a ninth transistor 570. In the example of FIG. 5, the offset circuitry 575 includes a resistor 580, a tenth transistor 585, and an error amplifier 590. The PSM entry circuitry 500 generates the PSM entry voltage responsive to the input and output voltages and the slope constant of the converter circuitry 300 of FIG. 3. The PSM entry circuitry 500 implements one of Equations (11) or (16) responsive to a comparison of the input voltage to the output voltage.

The V-I converter circuitry 505 has an input terminal that may be coupled to the input terminal of the converter circuitry 300 of FIG. 3, which supplies the input voltage of the converter circuitry 300, and an output terminal coupled to the transistors 535, 540. The V-I converter circuitry 505 is an example of the V-I converter circuitry 410 of FIG. 4. In example operation, the V-I converter circuitry 505 operates similar to the V-I converter circuitry 410. The V-I converter circuitry 505 supplies a first current, which is proportional to the input voltage of the converter circuitry 300 to the transistors 535, 540.

The V-I converter circuitry 510 has an input terminal that may be coupled to the output terminal of the converter circuitry 300, which supplies the output voltage of the converter circuitry 300, and an output terminal coupled to the transistors 520, 525. The V-I converter circuitry 510 is an example of the V-I converter circuitry 415 of FIG. 4. In example operation, the V-I converter circuitry 510 operates similar to the V-I converter circuitry 415. The V-I converter circuitry 510 supplies a second current, which is proportional to the output voltage of the converter circuitry 300 to the transistors 520, 525.

The comparison circuitry 515 has input terminals coupled to the V-I converter circuitry 505, 510 and an output terminal coupled to the scaling circuitry 555. The comparison circuitry 515 is an example of the comparison circuitry 420 of FIG. 4. In the example of FIG. 5, the comparison circuitry 515 includes the transistors 520, 525, 530, 535, 540, 545, 550. The comparison circuitry 515 generates a comparison output current responsive to comparing the first current and the second current. The comparison circuitry 515 supplies the greater of the first and second currents to the scaling circuitry 555 as the comparison output current.

The transistor 520 has a first current terminal coupled to the V-I converter circuitry 510, to a supply terminal, which supplies a supply voltage (V_{SUP}), and to the transistors 525, 530, a second current terminal coupled to the transistors 525, 530, and a control terminal coupled to the V-I converter circuitry 510, to the first current terminal, to the supply terminal, and to the transistors 525, 530. The transistor 525 has a first current terminal coupled to the transistors 540, 545, 550, a second current terminal coupled to the transistors 520, 530 and to the supply terminal, and a control terminal coupled to the V-I converter circuitry 510 and the transistors 520, 530. The transistor 530 has a first current terminal coupled to the transistors 550, 560, 570, a second current terminal coupled to the transistors 520, 525 and to the supply voltage, and a control terminal coupled to the V-I converter circuitry 510 and the transistors 520, 525.

The transistors 520, 525, 535 form current mirror circuitry. In example operations, the transistors 525, 530 mirror the current flowing through the transistor 520. In the example of FIG. 5, the current flowing through the transistor 520 is approximately equal to the second current from the V-I converter circuitry 510. Advantageously, the transistors 525, 530 supply replicated currents mirroring the second current to the transistors 540, and 560.

The transistor 535 has a first current terminal coupled to the V-I converter circuitry 505 and the transistor 540, a second current terminal coupled to a common terminal, which supplies a common potential (e.g., ground), and a control terminal coupled to the V-I converter circuitry 505, to the first current terminal, and to the transistor 540. The transistor 540 has a first current terminal coupled to the transistors 525, 545, 550, a second current terminal coupled to the common terminal, which supplies the common potential, and a control terminal coupled to the V-I converter circuitry 505 and the transistor 535.

The transistors 535, 540 form current mirror circuitry. In example operations, the transistor 540 mirrors the current flowing through the transistor 535. In the example of FIG. 5, the current flowing through the transistor 535 is approximately equal to the first current from the V-I converter circuitry 505. Advantageously, the transistor 540 sources a current from the transistors 525, 545 approximately equal to the first current.

The transistor 545 has a first current terminal coupled to the transistors 525, 540, 550, a second current terminal coupled to the transistor 550 and to the supply terminal, and a control terminal coupled to the transistors 525, 540, 550. The transistor 550 has a first current terminal coupled to the transistors 530, 560, 570, a second current terminal coupled to the transistor 545 and to the supply terminal, and a control terminal coupled to the transistors 525, 540, 545.

The transistors 545, 550 form current mirror circuitry. In example operations, the transistor 550 mirrors the current flowing through the transistor 545. In the example of FIG. 5, the current flowing through the transistor 545 is approximately equal to the first current minus the second current. However, when the second current is greater than the first current (e.g., the output voltage is greater than the input voltage), the transistor 545 supplies approximately zero current to the transistor 540. In such an example, the transistor 550 mirrors approximately zero current. When the first current is greater than the second current (e.g., the input voltage is greater than the output voltage), the transistors 545 supplies the difference between the first current and the second current to the transistor 545. In such example operations, the transistor 550 mirrors the current flowing through the transistor 545 and supplies the difference between the first and second currents to the transistor 560.

Advantageously, the comparison output current of the comparison circuitry 515 is approximately equal to the first current responsive to the converter circuitry 300 operating in a Buck mode of operation. Advantageously, the comparison output current of the comparison circuitry 515 is approximately equal to the second current responsive to the converter circuitry 300 operating in a Boost mode of operation. Advantageously, the PSM entry circuitry 500 uses the comparison circuitry 515 to select between using Equation (11) or (16) based on a comparison of the input voltage and the output voltage.

The scaling circuitry 555 has a first input terminal coupled to the comparison circuitry 515, a second input terminal that may be coupled to the slope constant circuitry 360 of FIG. 3, and an output terminal coupled to the offset circuitry 575. The scaling circuitry 555 is an example of the scaling circuitry 425 of FIG. 4. In the example of FIG. 5, the scaling circuitry 555 includes the transistors 560, 570 and the trim circuitry 565. The scaling circuitry 555 receives the comparison current output from the comparison circuitry 515 and the slope constant of the converter circuitry 300 from the slope constant circuitry 360. The scaling circuitry 555 generates a scaled current, which represents the PSM entry current, responsive to scaling (e.g., multiplying) the compensation current output by the slope constant. The scaling circuitry 555 sinks the scaled current from the offset circuitry 575.

The transistor 560 has a first current terminal coupled to the transistors 530, 550, 570, a second current terminal coupled to the common terminal, which supplies the common potential, and a control terminal coupled to the transistors 530, 550, 570 and to the first current terminal. The trim circuitry 565 has an input terminal that may be coupled to the slope constant circuitry 360 and an output terminal coupled to the transistor 570. The transistor 570 has a first current terminal coupled to the resistor 580 and the error amplifier 590, a second current terminal coupled to the common terminal, which supplies the common potential, a control terminal coupled to the transistors 530, 550, 560, and a gain terminal coupled to the trim circuitry 565.

The transistors 560, 570 form a current mirror. In example operations, the transistor 570 mirrors the current flowing through the transistor 560. In the example of FIG. 5, the current flowing through the transistor 560 is approximately equal to the comparison output current from the comparison circuitry 515. However, the trim circuitry 565 adjusts characteristics of the transistor 570 to scale the comparison output current. In example operations, the trim circuitry 565 determines a trim value of the transistor 570 that corresponds to the slope constant from the slope constant circuitry 360. In some examples, the trim circuitry 565 determines the trim value responsive to a multiplication of the slope constant and a derating value. The derating value is a ratio of a maximum inductance of the inductor 328, which occurs at a minimum inductor current, over a minimum inductance of the inductor 328, which occurs at a maximum inductor current. The trim circuitry 565 determines the trim value to adjust a sizing of the transistor 570 to scale the compensation output current based on the slope constant and/or the derating value. Advantageously, the scaled current of the scaling circuitry is proportional to the comparison output current times the slope constant, which is approximately equal to the PSM entry currents of Equations (9) or (15), above. The transistor 570 sources the current for the scaled current from the resistor 580.

The offset circuitry 575 has a first input terminal coupled to the scaling circuitry 555, a second input terminal coupled to the offset voltage 595, and an output terminal that may be coupled to the amplifier 440 of FIG. 4. The offset circuitry 575 is an example of the offset circuitry 430 of FIG. 4. In the example of FIG. 5, the offset circuitry 575 includes the resistor 580, the transistor 585, and the error amplifier 590. The scaling circuitry 555 sinks the scaled current from the offset circuitry 575. The offset circuitry 575 generates the PSM entry voltage by offsetting the offset voltage 595 based on a magnitude of the scaled current, which is determined by the input or output voltage and the slope constant.

The resistor 580 has a first terminal coupled to the transistor 570 and the error amplifier 590 and a second terminal coupled to the transistor 585 and that may be coupled to the amplifier 440. The transistor 585 has a first current terminal coupled to a supply terminal, which supplies a supply voltage (V_{SUP}), a second current terminal coupled to the resistor 580 and that may be coupled to the amplifier 440, and a control terminal coupled to the error amplifier 590. The error amplifier 590 has a first input terminal coupled to the transistor 570 and the resistor 580, a second input terminal coupled to the offset voltage 595, and an output terminal coupled to the transistor 585. The offset voltage 595 is coupled to the error amplifier 590. The offset voltage 595 is an example of the reference compensation voltage 435 of FIG. 4.

The resistor 580 sources the scaled current from the transistor 585 to supply current to the transistor 570. The error amplifier 590 controls the transistor 585. The resistor 580 and the transistor 585 form a feedback loop to regulate the voltage at the second input of the error amplifier 590. In example operation, the error amplifier 590 adjusts the transistor 585 to reduce differences between the input terminals of the error amplifier 590. In such example operations, the PSM entry voltage is approximately equal to the offset voltage 595 plus the voltage difference across the resistor 580. The amplifier 440 supplies a PSM entry value to the state machine circuitry 396 responsive to comparing the PSM entry voltage to the compensation voltage 465 of FIG. 4.

In the example of FIG. 5, the transistors 535, 540 560, 570, 585 are n-channel metal-oxide semiconductor field-effect transistors (MOSFETs). Alternatively, the transistors 535, 540 560, 570, 585 may be n-channel field-effect transistors (FETs), n-channel insulated-gate bipolar transistors (IGBTs), n-channel junction field effect transistors (JFETs), NPN bipolar junction transistors (BJTs) and/or, with slight modifications, p-type equivalent devices. In the example of FIG. 5, the transistors 520, 525, 530, 545, 550 are p-channel MOSFETs. Alternatively, the transistors 520, 525, 530, 545, 550 may be p-channel FETs, p-channel IGBTs, p-channel JFETs, NPN BJTs, and/or, with slight modifications, N-type equivalent devices. The transistors 520, 525, 530, 535, 540, 545, 550, 560, 570, 585 may be depletion mode devices, drain-extended devices, enhancement mode devices, natural transistors or other type of device structure transistors. Furthermore, the transistors 520, 525, 530, 535, 540, 545, 550, 560, 570, 585 may be implemented in/over a silicon substrate (Si), a silicon carbide substrate (SiC), a gallium nitride substrate (GaN) or a gallium arsenide substrate (GaAs).

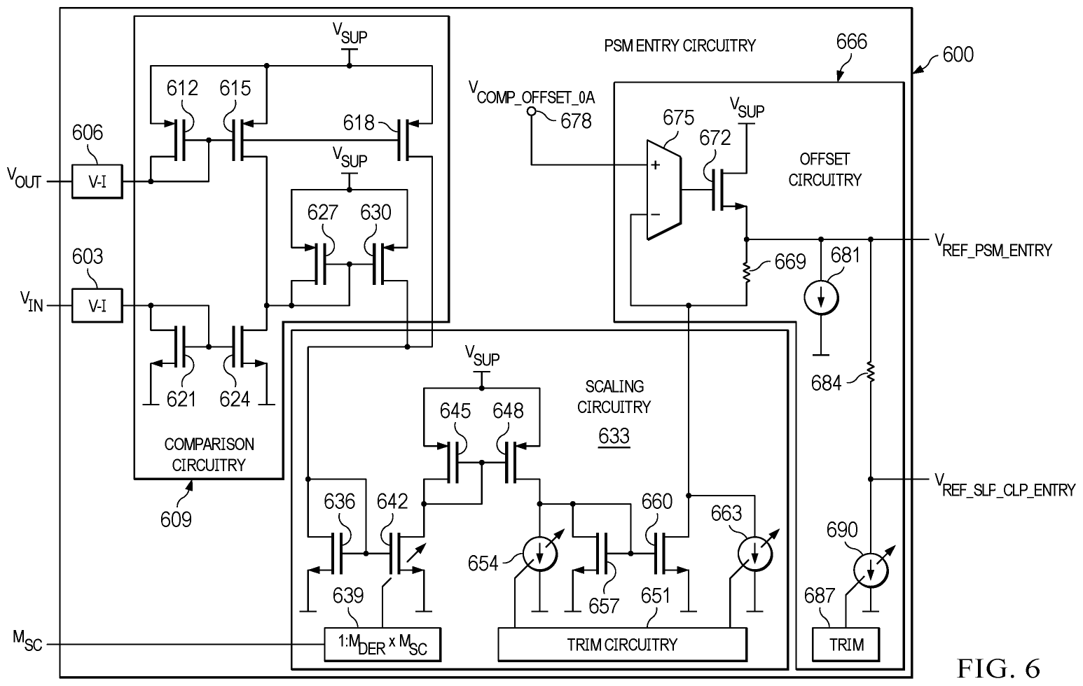

FIG. 6 is a schematic diagram of example PSM entry circuitry 600, which is another example of the PSM entry circuitry 405 of FIG. 4. In the example of FIG. 6, the PSM entry circuitry 600 includes first V-I converter circuitry 603, second V-I converter circuitry 606, comparison circuitry 609, scaling circuitry 633, offset circuitry 666, and an offset voltage 678. In the example of FIG. 6, the comparison circuitry 609 includes a first transistor 612, a second transistor 615, a third transistor 618, a fourth transistor 621, a fifth transistor 624, a sixth transistor 627, and a seventh transistor 630. In the example of FIG. 6, the scaling circuitry 633 includes an eighth transistor 636, first trim circuitry 639, a ninth transistor 642, a tenth transistor 645, an eleventh transistor 648, second trim circuitry 651, first current source circuitry 654, a twelfth transistor 657, a thirteenth transistor 660, and second current source circuitry 663. In the example of FIG. 6, the offset circuitry 666 includes a first resistor 669, a fourteenth transistor 672, an error amplifier 675, third current source circuitry 681, a second resistor 684, third trim circuitry 687, and fourth current source circuitry 690.

The PSM entry circuitry 600 generates the PSM entry voltage responsive to the input and output voltages and the slope constant of the converter circuitry 300 of FIG. 3. The PSM entry circuitry 600 implements one of Equations (11) or (16) responsive to a comparison of the input voltage to the output voltage.

The V-I converter circuitry 603 has an input terminal that may be coupled to the input terminal of the converter circuitry 300 of FIG. 3, which supplies the input voltage of the converter circuitry 300, and an output terminal coupled to the transistors 621, 624. The V-I converter circuitry 603 is an example of the V-I converter circuitry 410 of FIG. 4. The V-I converter circuitry 603 supplies a first current, which is proportional to the input voltage of the converter circuitry 300 to the transistors 621, 624.

The V-I converter circuitry 606 has an input terminal that may be coupled to the output terminal of the converter circuitry 300, which supplies the output voltage of the converter circuitry 300, and an output terminal coupled to the transistors 612, 615. The V-I converter circuitry 606 is an example of the V-I converter circuitry 415 of FIG. 4. The V-I converter circuitry 606 supplies a second current, which is proportional to the output voltage of the converter circuitry 300 to the transistors 612, 615.

The comparison circuitry 609 has input terminals coupled to the V-I converter circuitry 603, 510606 and an output terminal coupled to the scaling circuitry 633. The comparison circuitry 609 is an example of the comparison circuitry 420 of FIG. 4. In the example of FIG. 55, the comparison circuitry 609 includes the transistors 612, 615, 618, 621, 624, 627, 630. The comparison circuitry 609 generates a comparison output current responsive to comparing the first current and the second current from the V-I converter circuitry 603, 606. The comparison circuitry 609 supplies the greater of the first and second current to the scaling circuitry 633 as the comparison output current.

The transistor 612 has a first current terminal coupled to the V-I converter circuitry 606 and the transistors 615, 618, a second current terminal coupled to the transistors 615, 618 and to a supply terminal, which supplies a supply voltage (V_{SUP}), and a control terminal coupled to the V-I converter circuitry 606, to the second current terminal, and to the transistors 615, 618. The transistor 615 has a first current terminal coupled to the transistors 624, 627, 630, a second current terminal coupled to the transistors 612, 618 and to the supply terminal, and a control terminal coupled to the V-I converter circuitry 606 and the transistors 612, 618. The transistor 618 has a first current terminal coupled to the transistors 630, 636, 642, a second current terminal coupled to the transistors 612, 615 and to the supply terminal, and a control terminal coupled to the V-I converter circuitry 606 and the transistors 612, 615.

The transistors 612, 615, 618 form current mirror circuitry. In example operations, the transistors 615, 618 mirror the current flowing through the transistor 612. In the example of FIG. 6, the current flowing through the transistor 612 is approximately equal to the second current from the V-I converter circuitry 606. Advantageously, the transistors 615, 618 supply replicated currents mirroring the second current to the transistors 624, 636.

The transistor 621 has a first current terminal coupled to the V-I converter circuitry 603 and the transistor 624, a second current terminal coupled to a common terminal, which supplies a common potential (e.g., ground), and a control terminal coupled to the V-I converter circuitry 603, to the first current terminal, and to the transistor 624. The transistor 624 has a first current terminal coupled to the transistors 615, 627, 630, a second current terminal coupled to the common terminal, which supplies the common potential, and a control terminal coupled to the V-I converter circuitry 603 and the transistor 621.

The transistors 621, 624 form current mirror circuitry. In example operations, the transistor 624 mirrors the current flowing through the transistor 621. In the example of FIG. 6, the current flowing through the transistor 621 is approximately equal to the first current from the V-I converter circuitry 603. Advantageously, the transistor 624 sources a current from the transistors 615, 627 approximately equal to the first current.

The transistor 627 has a first current terminal coupled to the transistors 615, 624, 630, a second current terminal coupled to the transistor 630 and to the supply terminal, and a control terminal coupled to the transistors 615, 624, 630. The transistor 630 has a first current terminal coupled to the transistors 618, 636, 642, a second current terminal coupled to the transistor 627 and the supply terminal, and a control terminal coupled to the transistors 615, 624, 627.

The transistors 627, 630 form current mirror circuitry. In example operations, the transistor 630 mirrors the current flowing through the transistor 627. In the example of FIG. 6, the current flowing through the transistor 627 is approximately equal to the first current minus the second current, which represent the input and output voltage of the converter circuitry and are from the V-I converter circuitry 603, 606. However, when the second current is greater than the first current (e.g., the output voltage is greater than the input voltage), the transistor 627 supplies approximately zero current to the transistor 624. In such an example, the transistor 630 mirrors approximately zero current. When the first current is greater than the second current (e.g., the input voltage is greater than the output voltage), the transistors 627 supplies the difference between the first current and the second current to the transistor 627. In such example operations, the transistor 630 mirrors the current flowing through the transistor 627 and supplies the difference between the first and second currents to the transistor 636.

Advantageously, the comparison output current of the comparison circuitry 609 is approximately equal to the first current responsive to the converter circuitry 300 operating in a Buck mode of operation. Advantageously, the comparison output current of the comparison circuitry 609 is approximately equal to the second current responsive to the converter circuitry 300 operating in a Boost mode of operation. Advantageously, the PSM entry circuitry 500 uses the comparison circuitry 609 to select between using Equation (11) or (16) based on a comparison of the input voltage and the output voltage.

The scaling circuitry 633 has a first input terminal coupled to the comparison circuitry 609, a second input terminal that may be coupled to the slope constant circuitry 360 of FIG. 3, and an output terminal coupled to the offset circuitry 666. The scaling circuitry 633 is another example of the scaling circuitry 425 of FIG. 4. In the example of FIG. 6, the scaling circuitry 633 includes the transistors 636, 642, 645, 648, 657, 660, the trim circuitry 639, 651, and the current source circuitry 654, 663. The scaling circuitry 633 receives the comparison current output from the comparison circuitry 609 and the slope constant of the converter circuitry 300 from the slope constant circuitry 360. The scaling circuitry 633 generates a scaled current, which is proportional to the PSM entry current, responsive to scaling (e.g., multiplying) the compensation current output by the slope constant. The scaling circuitry 633 sinks the scaled current from the offset circuitry 666.

The transistor 636 has a first current terminal coupled to the transistors 618, 630, 642, a second current terminal coupled to the common terminal, which supplies the common potential, and a control terminal coupled to the transistors 618, 630, 642 and to the first current terminal. The trim circuitry 639 has an input terminal that may be coupled to the slope constant circuitry 360 and an output terminal coupled to the transistor 642. The transistor 642 has a first current terminal coupled to the transistors 645, 648, a second current terminal coupled to the common terminal, which supplies the common potential, a control terminal coupled to the transistors 618, 630, 636, and a gain terminal coupled to the trim circuitry 639.

The transistors 636, 642 form a current mirror. In example operations, the transistor 642 mirrors the current flowing through the transistor 636. In the example of FIG. 6, the current flowing through the transistor 636 is approximately equal to the comparison output current from the comparison circuitry 609. However, the trim circuitry 639 adjusts characteristics of the transistor 642 to scale the comparison output current. In example operations, the trim circuitry 639 determines a trim value of the transistor 642 that corresponds to the slope constant from the slope constant circuitry 360. In some examples, the trim circuitry 639 determines the trim value responsive to a multiplication of the slope constant and a derating value. The derating value is a ratio of a maximum inductance of the inductor 328, which occurs at a minimum inductor current, over a minimum inductance of the inductor 328, which occurs at a maximum inductor current. The trim circuitry 639 determines the trim value to adjust a sizing of the transistor 642 to scale the compensation output current based on the slope constant and/or the derating value. Advantageously, the scaled current of the scaling circuitry is proportional to the comparison output current times the slope constant, which is approximately equal to the PSM entry currents of Equations (9) or (15), above. The transistor 642 sources the current for the scaled current from the resistor 580. Advantageously, the transistor 624 sources a current from the transistors 615, 627 approximately equal to the first current.

The transistor 645 has a first current terminal coupled to the transistors 642, 648, a second current terminal coupled to the transistor 648 and the supply terminal, which supplies the supply voltage, and a control terminal coupled to the transistors 642, 648. The transistor 648 has a first current terminal coupled to the current source circuitry 654 and the transistors 657, 660, a second current terminal coupled to the transistor 645 and the supply terminal, which supplies the supply voltage, and a control terminal coupled to the transistors 642, 645.

The transistors 645, 648 form current mirror circuitry. In example operations, the transistor 645 mirrors the current flowing through the transistor 642. In the example of FIG. 6, the current flowing through the transistor 648 is approximately equal to the scaled current from the transistor 642. Advantageously, the transistor 648 supplies a replica of the scaled current to the current source circuitry 654 and the transistor 657.

The trim circuitry 651 has a first output terminal coupled to the current source circuitry 654 and a second output terminal coupled to the current source circuitry 663. The current source circuitry 654 has a first terminal coupled to the transistors 648, 657, 660, a second terminal coupled to the common terminal, which supplies the common potential, and a control terminal coupled to the trim circuitry 651. The transistor 657 has a first current terminal coupled to the transistors 648, 660 and the current source circuitry 654, a second current terminal coupled to the common terminal, which supplies the common potential, and a control terminal coupled to the transistors 648, 660, to the first current terminal, and to the current source circuitry 654. The transistor 660 has a first current terminal coupled to the current source circuitry 663, the resistor 669, and the error amplifier 675, a second current terminal coupled to the common terminal, which supplies the common potential, and a control terminal coupled to the transistors 648, 657 and the current source circuitry 654. The current source circuitry 663 has a first terminal coupled to the transistor 660, the resistor 669, and the error amplifier 675, a second terminal coupled to the common terminal, which supplies the common potential, and a control terminal coupled to the trim circuitry 651.

The trim circuitry 651 controls the current source circuitry 654. In some examples, the current source circuitry 654 sources a current from the transistor 648 responsive to a trim code value from the trim circuitry 651. In such examples, the trim circuitry 651 sets the current flowing through the current source circuitry 654 to offset the scaled current from the transistor 648 and to set a minimum PSM entry current. The minimum PSM entry current sets a minimum current to be sunk by the scaling circuitry 633, which ensures the offset circuitry 666 generates a PSM entry voltage at a minimum distance from the offset voltage 678.

The transistors 657, 660 form a current mirror. In example operations, the transistor 657 mirrors the current flowing through the transistor 648 minus the current being sunk by the current source circuitry 654. The transistor 657 offsets the scaled current by the current flowing through the current source circuitry 654.

The trim circuitry 651 controls the current source circuitry 663. In some examples, the current source circuitry 663 sources a current from the resistor 669 responsive to a trim code value from the trim circuitry 651. In such examples, the trim circuitry 651 sets the current flowing through the current source circuitry 654 to set the minimum PSM entry current. In example operation, the scaling circuitry 633 sources a PSM entry current from the offset circuitry 666 approximately equal to the scaled current from the transistor 648 minus the offset current and plus the minimum PSM entry current. Advantageously, the current source circuitry 654, 663 of FIG. 4 allow the scaling circuitry 633 to offset PSM entry current and set a minimum PSM entry current. Alternatively, in some example the scaling circuitry 633 may be modified to include one or more instances of trim circuitry to separate the trim operations of the trim circuitry 651. For example, the trim circuitry 651 may be replaced with first and second trim circuitry.

The offset circuitry 666 has a first input terminal coupled to the scaling circuitry 633, a second input terminal coupled to the offset voltage 678, a first output terminal that may be coupled to the amplifier 440 of FIG. 4, and a second output terminal that may be coupled to the amplifier 445 of FIG. 4. The offset circuitry 666 is another example of the offset circuitry 430 of FIG. 4. In the example of FIG. 6, the offset circuitry 666 includes the resistors 669, 684, the transistor 672, the error amplifier 675, the current source circuitry 681, 690, and the trim circuitry 687. The offset circuitry 666 generates the PSM entry voltage by offsetting the offset voltage 678. The offset circuitry 666 generates the sleep clamp voltage by offsetting the PSM entry voltage based on a magnitude of the PSM entry current, which is determined by the input or output voltage, the slope constant, the offset current, the minimum PSM entry current, and/or a derating value. The offset circuitry 666 may supply the PSM entry voltage and/or the sleep clamp voltage to the amplifiers 440, 445 of FIG. 4.

The resistor 669 has a first terminal coupled to the transistor 660, the current source circuitry 663, and the error amplifier 675 and a second terminal coupled to the transistor 672, the current source circuitry 681, the resistor 684, and that may be coupled to the amplifier 440. The transistor 672 has a first current terminal coupled to a supply terminal, which supplies a supply voltage (V_{SUP}), a second current terminal coupled to the resistor 669, the current source circuitry 681, the resistor 684, and that may be coupled to the amplifier 440, and a control terminal coupled to the error amplifier 675. The error amplifier 675 has a first input terminal coupled to the transistor 660, the current source circuitry 663, and the resistor 669, a second input terminal coupled to the offset voltage 678, and an output terminal coupled to the transistor 672. The offset voltage 678 is coupled to the error amplifier 675. The offset voltage 678 is another example of the reference compensation voltage 435 of FIG. 4.

The resistor 669 sources the scaled current from the transistor 672 to supply current to the transistor 642. The error amplifier 675 controls the transistor 672. The resistor 669 and the transistor 672 form a feedback loop to regulate the voltage at the second input of the error amplifier 675. In example operation, the error amplifier 675 adjusts the transistor 672 to reduce differences between the input terminals of the error amplifier 675. In such example operations, the PSM entry voltage is approximately equal to the offset voltage 678 plus the voltage difference across the resistor 669. The amplifier 440 supplies a PSM entry value to the state machine circuitry 396 responsive to comparing the PSM entry voltage to the compensation voltage 465 of FIG. 4.

The current source circuitry 681 has a first terminal coupled to the resistors 669, 684, the transistor 672, and that may be coupled to the amplifier 440, and a second terminal coupled to the common terminal, which supplies the common potential. The current source circuitry 681 sinks a bias current from the transistor 672. In example operation, the current source circuitry 681 reduces the current supplied to the amplifier 440.

The resistor 684 has a first terminal coupled to the resistor 669, the transistor 672, the current source circuitry 681, and that may be coupled to the amplifier 440 and a second terminal coupled to the current source circuitry 690 and that may be coupled to the amplifier 445. The trim circuitry 687 has a terminal coupled to the current source circuitry 690. The current source circuitry 690 has a first terminal coupled to the resistor 684 and that may be coupled to the amplifier 445, a second terminal coupled to the common terminal, which supplies the common potential, and a control terminal coupled to the trim circuitry 687.

The trim circuitry 687 controls the current source circuitry 690. In some examples, the current source circuitry 690 sources a current from the resistor 684 responsive to a trim code value from the trim circuitry 687. In such examples, the trim circuitry 687 sets the current flowing through the current source circuitry 690 to offset the PSM entry voltage. The resistor 684 generates the sleep clamp voltage by offsetting the PSM entry voltage by a value approximately equal to the current through the current source circuitry 690 times the resistance of the resistor 684. Advantageously, adjusting the current source circuitry 690 modifies the sleep clamp voltage. In some examples, the resistor 684 supplies the sleep clamp voltage to the amplifier 445.

In the example of FIG. 6, the transistors 621, 624, 636, 642, 657, 660, 672 are n-channel metal-oxide semiconductor field-effect transistors (MOSFETs). Alternatively, the transistors 621, 624, 636, 642, 657, 660, 672 may be n-channel field-effect transistors (FETs), n-channel insulated-gate bipolar transistors (IGBTs), n-channel junction field effect transistors (JFETs), NPN bipolar junction transistors (BJTs) and/or, with slight modifications, p-type equivalent devices. In the example of FIG. 5, the transistors 612, 615, 618, 627, 630, 645, 648 are p-channel MOSFETs. Alternatively, the transistors 612, 615, 618, 627, 630, 645, 648 may be p-channel FETs, p-channel IGBTs, p-channel JFETs, NPN BJTs, and/or, with slight modifications, N-type equivalent devices. The transistors 612, 615, 618, 621, 624, 627, 630, 636, 642, 645, 648, 657, 660, 672 may be depletion mode devices, drain-extended devices, enhancement mode devices, natural transistors or other type of device structure transistors. Furthermore, the transistors 612, 615, 618, 621, 624, 627, 630, 636, 642, 645, 648, 657, 660, 672 may be implemented in/over a silicon substrate (Si), a silicon carbide substrate (SiC), a gallium nitride substrate (GaN) or a gallium arsenide substrate (GaAs).

FIG. 7 is a plot 700 of example operations of the PSM entry circuitry 405, 500, 600 of FIGS. 4, 5, and 6 and/or more generally the converter circuitry 230, 300 of FIGS. 1, 2, and 3. In the example of FIG. 7, the plot 700 illustrates an example inductor ripple current plot 710 and an example PSM entry value plot 720 across a range of input voltages. The inductor ripple current plot 710 illustrates the ripple current through the inductor 328 of FIG. 3 across a range of input voltages of the converter circuitry 300.

When the input voltage of the converter circuitry 300 is less than the output voltage of the converter circuitry 300, such as in Boost operations, the inductor ripple current plot 710 follows Equation (5), above. Such example operations occur when the input voltage of the converter circuitry is between a first and second voltages 730, 740. The input voltage 740 is approximately equal to the output voltage of the converter circuitry 300. At a third input voltage 750, which is approximately one-half of the output voltage, the inductor ripple current plot 710 is at a maximum for Boost mode of operations. The value of the inductor ripple current plot 710 at the input voltage 750 may be determined using Equation (6), above.

When the input voltage of the converter circuitry 300 is greater than the output voltage of the converter circuitry 300, such as in Buck operations, the inductor ripple current plot 710 follows Equation (12), above. Such example operations occur when the input voltage of the converter circuitry is greater than the input voltage 740. At a fourth input voltage 760, which is approximately two times the output voltage, the inductor 328 is near a boundary conduction condition. The value of the inductor ripple current plot 710 at the input voltage 760 may be determined using Equation (13), above.

The PSM entry value plot 720 illustrates the PSM entry value across a range of input voltages of the converter circuitry 300. The PSM entry value plot 720 is set based on the input and output voltage and a slope constant of the converter circuitry 300. When in a Boost mode of operation, the PSM entry value occurs at the ripple current value that occurs at the input voltage 750. In such examples, the value of the inductor ripple current plot 710 may be determined using Equation (9), above. When in a Buck mode of operation, the PSM entry value occurs at the ripple current value that occurs at the input voltage 760. In such examples, the value of the inductor ripple current plot 710 may be determined using Equation (15), above. Advantageously, the PSM entry circuitry 405, 500, 600 of FIGS. 4, 5, and 6 adjusts the PSM entry value based on the input and output voltage of the converter circuitry 300.

FIG. 8 is a plot 800 of example operations of the PSM entry circuitry 405, 500, 600 of FIGS. 4, 5, and 6. In the example of FIG. 8, the plot 800 includes an example inductor current plot 810, an example offset voltage 820, an example PSM entry value 830, an example minimum compensation voltage 840, and an example maximum compensation voltage 850. The inductor current plot 810 illustrates the current through the inductor 328 of FIG. 3 across a range of compensation voltages, such as the compensation voltage 465 of FIG. 4. The offset voltage 820 illustrates the reference compensation voltages 435, 595, 678 of FIGS. 4, 5, and 6. The offset voltage 820 is the compensation voltage that corresponds to the inductor current being approximately zero. The PSM entry value 830 illustrates the PSM entry point determined by the PSM entry circuitry 405, 500, 600. The PSM entry value 830 corresponds to a fraction between the compensation voltages 840, 850. When the current through the inductor 328 is approximately equal to the PSM entry value 830, the converter circuitry 300 enters the power saving mode.

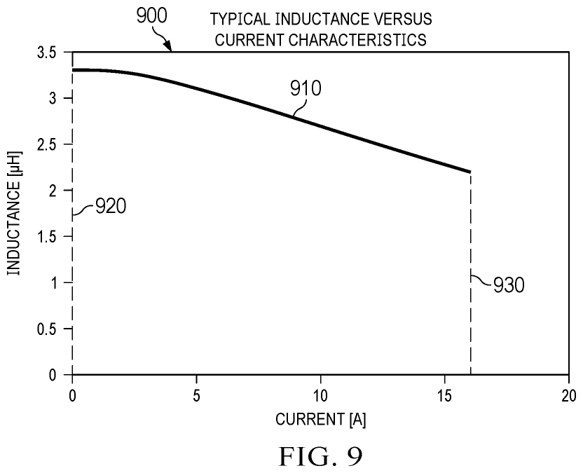

FIG. 9 is a plot 900 of an example derating of an inductance of the converter circuitry 230, 300 of FIGS. 2 and 2. In the example of FIG. 9, the plot 900 includes an example inductance plot 910, which illustrates the inductance of the inductor 328 of FIG. 3 across a range of inductor currents. The inductor 328 has a first inductance at a first example current 920. As the current through the inductor 328 increases, the inductance of the inductor 328 decreases to a second inductance at a second example current 930. The current 920 is approximately zero, while the current 930 is approximately a maximum current through the inductor 328. In example operation, the scaling circuitry 425, 555, 633 of FIGS. 4, 5, and 6 may account for the derating of the inductor 328 by scaling the comparison current by a value of the second inductance divided by the first inductance times the slope constant. Advantageously, the PSM entry circuitry 405, 500, 600 of FIGS. 4, 5, and 6 adjust the PSM entry value to account for derating of the inductor 328.

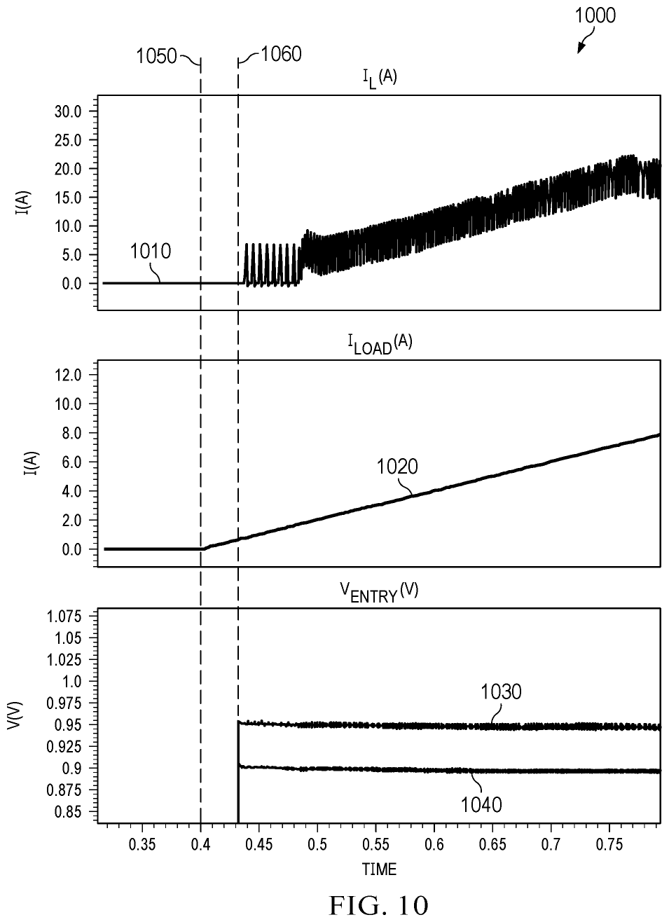

FIG. 10 is a timing diagram 1000 of example Boost mode operations of the converter circuitry 230, 300 of FIGS. 1, 2, and 3. In the example of FIG. 10, the timing diagram 1000 illustrates an example inductor current 1010, an example load current 1020, an example PSM entry voltage 1030, and an example sleep clamp voltage 1040. The inductor current 1010 illustrates the current through the inductor 328 of FIG. 3 during example Boost mode operations of the converter circuitry 300. In the example of FIG. 10, the inductor current 1010 illustrates the inductor ripple current as relatively high-speed switching. The load current 1020 illustrates an output current, which is supplied to a load, of the converter circuitry 300 responsive to the example Boost mode operations of the converter circuitry 300. The PSM entry voltage 1030 illustrates the PSM entry voltage of the PSM entry circuitry 405, 500, 600 of FIGS. 4, 5, and 6. The sleep clamp voltage 1040 illustrates the sleep clamp voltage of the PSM entry circuitry 405, 600.

In example operation, the converter circuitry 230, 300 regulates switching of the inductor current 1010 between the PSM entry voltage 1030 and the sleep clamp voltage 1040. At a first time 1050, the converter circuitry 300 begins switching operations, which begins to increase the load current 1020. At a second time 1060, the PSM entry circuitry 405, 500, 600 of FIGS. 4, 5, and 6 generate the PSM entry voltage, which sets the PSM entry point, and the sleep clamp voltage, which sets the sleep clamp value. After the time 1060, the inductor ripple current of the inductor current 1010 switches between the PSM entry voltage 1030 and the sleep clamp voltage 1040.

FIG. 220 is a timing diagram 1100 of example Buck mode operations of the converter circuitry 230, 300 of FIGS. 1, 2, and 3. In the example of FIG. 220, the timing diagram 1100 illustrates an example inductor current 1110, an example load current 1120, an example PSM entry voltage 1130, and an example sleep clamp voltage 1140. The inductor current 1110 illustrates the current through the inductor 328 of FIG. 3 during example Buck mode operations of the converter circuitry 300. In the example of FIG. 220, the inductor current 1110 illustrates the inductor ripple current as relatively high-speed switching. The load current 1120 illustrates an output current, which is supplied to a load, of the converter circuitry 300 responsive to the example Buck mode operations of the converter circuitry 300. The PSM entry voltage 1130 illustrates the PSM entry voltage of the PSM entry circuitry 405, 500, 600 of FIGS. 4, 5, and 6. The sleep clamp voltage 1140 illustrates the sleep clamp voltage of the PSM entry circuitry 405, 600.

In example operation, the converter circuitry 230, 300 regulates switching of the inductor current 1110 between the PSM entry voltage 1130 and the sleep clamp voltage 1140 to generate the load current 1120. At a first time 1150, the converter circuitry 300 begins switching operations, which begins to increase the load current 1120. At a second time 1160, the PSM entry circuitry 405, 500, 600 of FIGS. 4, 5, and 6 generate the PSM entry voltage, which sets the PSM entry point, and the sleep clamp voltage, which sets the sleep clamp value. At the time 1160, the inductor ripple current of the inductor current 1110 switches between the PSM entry voltage 1130 and the sleep clamp voltage 1140.

At a third time 1170, the converter circuitry 300 enters a discontinuous conduction mode (DCM). During DCM, the converter circuitry 300 stops switching operations to allow the inductor 328 to discharge. At a fourth time 1180, the converter circuitry 300 resumes switching operations. When switching, the PSM entry circuitry 405, 500, 600 generates a PSM entry voltage. Advantageously, the PSM entry circuitry 405, 500, 600 generate the PSM entry voltage responsive to operations of the converter circuitry 300.

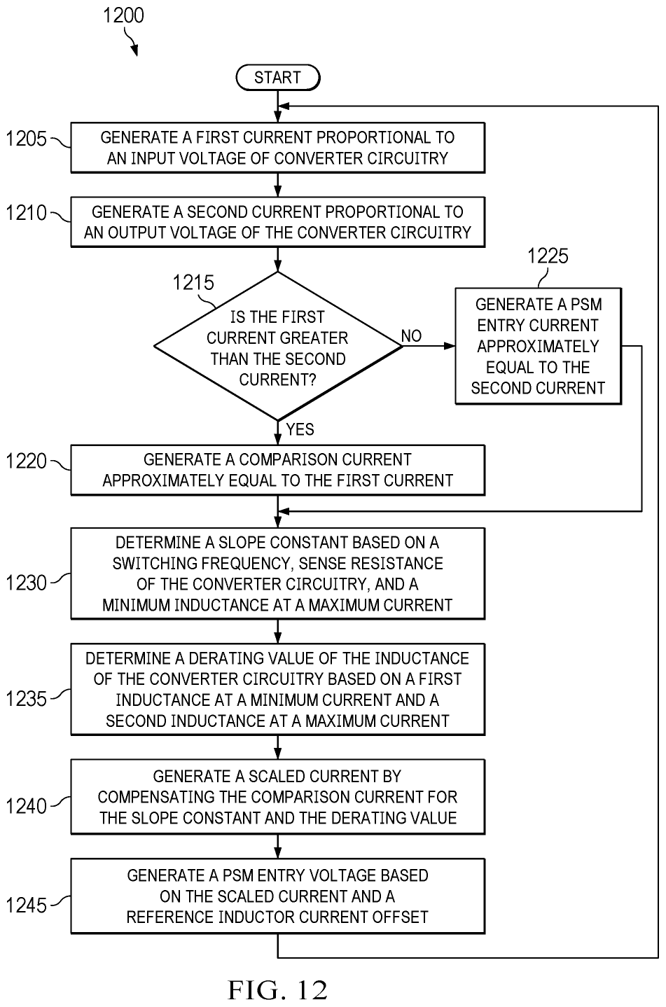

FIG. 12 is a flowchart representative of example operations 1200 that may be executed, instantiated, and/or performed to implement PSM entry circuitry 405, 500, 600 of FIGS. 4, 5, and 6 to generate a PSM entry voltage responsive to an input voltage and an output voltage of the converter circuitry 230, 300 of FIGS. 1, 2, and 3. The example operation 1200 begin at Block 1205, at which, the V-I converter circuitry 410 of FIG. 4 generates a first current proportional to an input voltage of converter circuitry. (Block 1205). In some examples, the V-I converter circuitry 410, 505, 603 of FIGS. 4, 5, and 6 convert the input voltage of the converter circuitry 300 into a first current, which is proportional to the input voltage.

The V-I converter circuitry 415 of FIG. 4 generates a second current proportional to an output voltage of the converter circuitry. (Block 1210). In some examples, the V-I converter circuitry 415, 510, 606 of FIGS. 4, 5, and 6 convert the output voltage of the converter circuitry 300 into a second current, which is proportional to the output voltage.

The comparison circuitry 420 of FIG. 4 determines if the first current is greater than the second current. (Block 1215). In some examples, the comparison circuitry 420, 515, 609 of FIGS. 4, 5, and 6 compares the first current, which represents the input voltage, to the second current, which represents the output voltage. In such examples, the comparison circuitry 420, 515, 609 determine which current is greater.

If the comparison circuitry 420 determines that the first current is greater than the second current (e.g., Block 1215 returns a result of YES), the comparison circuitry 420, 515, 609 generates a comparison current approximately equal to the first current. (Block 1220). In some examples, when the first current is greater than the second current, the comparison circuitry 420, 515, 609 generates a comparison output current approximately equal to the first current. In such an example, the comparison circuitry 420, 515, 609 determines that the converter circuitry 300 is operating in a Buck mode of operation. In such operations, the input voltage of the converter circuitry 300 is greater than the output voltage of the converter circuitry 300.

If the comparison circuitry 420 determines that the first current is less than the second current (e.g., Block 1215 returns a result of NO), the comparison circuitry 420 generates a comparison current approximately equal to the second current. (Block 1225). In some examples, when the second current is greater than the first current, the comparison circuitry 420, 515, 609 generates a comparison output current approximately equal to the second current. In such an example, the comparison circuitry 420, 515, 609 determines that the converter circuitry 300 is operating in a Boost mode of operation. In such operations, the input voltage of the converter circuitry 300 is less than the output voltage of the converter circuitry 300. Advantageously, the comparison circuitry 420, 515, 609 determines a mode of operation of the converter circuitry 300.

The slope constant circuitry 360 of FIG. 3 determines a slope constant based on a switching frequency, sense resistance of the converter circuitry, and a minimum inductance at a maximum current. (Block 1230). In some examples, the slope constant circuitry 360 determines the slope constant of the switching circuitry 300304 using Equation (1), above. In other examples, the slope constant circuitry 360 stores the slope constant of the switching circuitry 204. In such examples, the slope constant is determined using Equation (1) during manufacture or at startup. In yet another example, the slope constant circuitry 360 determines the slope constant using Equation (1) and one or more predetermined values, such as a fixed sense resistance value.

The scaling circuitry 425 of FIG. 4 determines a derating value of the inductance of the converter circuitry based on a first inductance at a minimum current and a second inductance at a maximum current. (Block 1235). In some examples, the trim circuitry 565, 639 of FIGS. 4 and 5 determine a derating value of the inductor 328. In such examples, the derating value is approximately equal to the minimum inductance, which occurs at a maximum current through the inductor 328, divided by the maximum inductance, which occurs at a minimum current through the inductor 328. Examples of such inductances are illustrated in FIG. 9.

The scaling circuitry 425 generates a scaled current by compensating the comparison current for the slope constant and the derating value. (Block 1240). In some examples, the trim circuitry 565, 639 modifies characteristics of current mirror circuitry (e.g., the transistors 570, 642 of FIGS. 4 and 5) to adjust the scaling of current being mirrored. In such examples, the trim circuitry 565, 639 scales the comparison current by a gain of the derating value times the slope constant.

The offset circuitry 430 of FIG. 4 generates a PSM entry voltage based on the scaled current and a reference inductor current offset. (Block 1245). In some examples, the offset circuitry 430, 575, 666 of FIGS. 4, 5, and 6 offset the reference compensation voltages 435, 595, 678 of FIGS. 4, 5, and 6 based on the scaled comparison current to generate the PSM entry voltage.

Although example methods are described with reference to the flowchart illustrated in FIG. 12, many other methods of implementing the PSM entry circuitry 405, 500, 600 may alternatively be used in this description. For example, the order of execution of the blocks may be changed, and/or some of the blocks described may be changed, eliminated, or combined. Similarly, additional operations may be included in the manufacturing process before, in between, or after the blocks shown in the illustrated examples.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of structure and/or function. These identifiers as used in the detailed description do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. An apparatus comprising:
switching converter circuitry having an input terminal and an output terminal; and
peak current control circuitry coupled to the switching converter circuitry, the peak current control circuitry including:
error amplifier having an input terminal and an output terminal;
power saving mode (PSM) entry circuitry having a first input terminal, a second input terminal, and an output terminal, the first input terminal of the PSM entry circuitry coupled to the input terminal of the switching converter circuitry, the second input terminal of the PSM entry circuitry coupled to the output terminal of the switching converter circuitry and the input terminal of the error amplifier; and
comparison circuitry having a first input terminal and a second input terminal, the first input terminal of the comparison circuitry coupled to the output terminal of the error amplifier, the second input terminal of the comparison circuitry coupled to the output terminal of the PSM entry circuitry.

2. The apparatus of claim 1, wherein the switching converter circuitry includes:
an inductor having a first terminal and a second terminal;
a first transistor having a first terminal and a second terminal, the first terminal of the first transistor coupled to the first terminal of the inductor, the second terminal of the first transistor coupled to the input terminal of the error amplifier and the second input terminal of the PSM entry circuitry;
current sense circuitry having a first terminal and a second terminal, the first terminal of the current sense circuitry coupled to the second terminal of the inductor; and
a second transistor having a first terminal and a second terminal, the first terminal of the second transistor coupled to the second terminal of the current sense circuitry, the second terminal of the second transistor coupled to the first input terminal of the PSM entry circuitry.

3. The apparatus of claim 1, wherein the output terminal of the switching converter circuitry is a first output terminal, the input terminal of the switching converter circuitry is a first input terminal, the switching converter circuitry further having a second input terminal and a second output terminal, the comparison circuitry further having an output terminal, and the comparison circuitry is first comparison circuitry, the apparatus further comprising:
second comparison circuitry having a first input terminal, a second input terminal, and an output terminal, the first input terminal of the second comparison circuitry coupled to the second output terminal of the switching converter circuitry, the second input terminal of the second comparison circuitry coupled to the output terminal of the error amplifier;
a state machine having a first input terminal, a second input terminal, and an output terminal, the first input terminal of the state machine coupled to the output terminal of the second comparison circuitry, the second input terminal of the state machine coupled to the output terminal of the first comparison circuitry; and
driver circuitry having an input terminal and an output terminal, the input terminal of the driver circuitry coupled to the output terminal of the state machine, the output terminal of the driver circuitry coupled to the second input terminal of the switching converter circuitry.

4. The apparatus of claim 3, wherein the PSM entry circuitry further has a third input terminal, the apparatus further comprising
compensation current circuitry having an input terminal and an output terminal, the input terminal of the compensation current circuitry coupled to the third input terminal of the PSM entry circuitry;
multiplication circuitry having a first input terminal, a second input terminal, a third input terminal, and an output terminal, the first input terminal of the multiplication circuitry coupled to the input terminal of the switching converter circuitry, the second input terminal of the multiplication circuitry coupled to the output terminal of the switching converter circuitry, the third input terminal of the multiplication circuitry coupled to the output terminal of the compensation current circuitry; and
slope compensation circuitry having an input terminal and an output terminal, the input terminal of the slope compensation circuitry coupled to the output terminal of the multiplication circuitry, the output terminal of the slope compensation circuitry coupled to the second output terminal of the switching converter circuitry and the first input terminal of the second comparison circuitry.

5. The apparatus of claim 3, wherein the peak current control circuitry further includes voltage-to-current (V-I) converter circuitry having an input terminal and an output terminal, the input terminal of the V-I converter circuitry coupled to the output terminal of the error amplifier and the first input terminal of the first comparison circuitry, the output terminal of the V-I converter circuitry coupled to the second input terminal of the second comparison circuitry.

6. The apparatus of claim 1, wherein the PSM entry circuitry includes:
comparison circuitry having a first input terminal, a second input terminal, and an output terminal, the first input terminal of the comparison circuitry coupled to the input terminal of the switching converter circuitry, the second input terminal of the comparison circuitry coupled to the output terminal of the switching converter circuitry and the input terminal of the error amplifier;
scaling circuitry having an input terminal and an output terminal, the input terminal of the scaling circuitry coupled to the output terminal of the comparison circuitry; and
offset circuitry having an input terminal and an output terminal, the input terminal of the offset circuitry coupled to the output terminal of the scaling circuitry, the output terminal of the offset circuitry coupled to the second input terminal of the comparison circuitry.

7. The apparatus of claim 6, wherein the PSM entry circuitry further includes:
first voltage-to-current (V-I) converter circuitry having an input terminal and an output terminal, the input terminal of the first V-I converter circuitry coupled to the input terminal of the switching converter circuitry, the output terminal of the first V-I converter circuitry coupled to the first input terminal of the comparison circuitry; and
second V-I converter circuitry having an input terminal and an output terminal, the input terminal of the second V-I converter circuitry coupled to the output terminal of the switching converter circuitry and the input terminal of the error amplifier, the output terminal of the second V-I converter circuitry coupled to the second input terminal of the comparison circuitry.

8. An apparatus comprising:
error amplifier having an input terminal and an output terminal;
power saving mode (PSM) entry circuitry coupled to the error amplifier, the PSM entry circuitry including:
comparison circuitry having an input terminal and an output terminal, the input terminal of the comparison circuitry adaptive to be coupled to the input terminal of the error amplifier;
scaling circuitry having an input terminal and an output terminal, the input terminal of the scaling circuitry coupled to the output terminal of the comparison circuitry; and
offset circuitry having an input terminal and an output terminal, the input terminal of the offset circuitry coupled to the output terminal of the scaling circuitry; and
comparison circuitry having a first input terminal and a second input terminal, the first input terminal of the comparison circuitry coupled to the output terminal of the error amplifier, the second input terminal of the comparison circuitry coupled to the output terminal of the offset circuitry.

9. The apparatus of claim 8, wherein the input terminal of the comparison circuitry is a first input terminal, the comparison circuitry further having a second input terminal, the apparatus further comprising switching converter circuitry having an input terminal and an output terminal, the input terminal of the switching converter circuitry coupled to the second input terminal of the comparison circuitry, the output terminal of the switching converter circuitry coupled to the input terminal of the error amplifier and the first input terminal of the comparison circuitry.

10. The apparatus of claim 8, wherein the input terminal of the comparison circuitry is a first input terminal, the comparison circuitry further having a second input terminal, and the PSM entry circuitry further including:
first voltage-to-current (V-I) converter circuitry having an input terminal and an output terminal, the input terminal of the first V-I converter circuitry coupled to the input terminal of the error amplifier, the output terminal of the first V-I converter circuitry coupled to the first input terminal of the comparison circuitry; and
second V-I converter circuitry having an output terminal coupled to the second input terminal of the comparison circuitry.

11. The apparatus of claim 8, wherein the comparison circuitry comprising:
first current mirror circuitry having an output terminal;
second current mirror circuitry having an input terminal, a first output terminal, and a second output terminal, the input terminal of the second current mirror circuitry coupled to the input terminal of the error amplifier;
third current mirror circuitry having an input terminal and an output terminal, the input terminal of the third current mirror circuitry coupled to the output terminal of the first current mirror circuitry and the first output terminal of the second current mirror circuitry; and
a transistor having a current terminal and a control terminal, the current terminal of the transistor coupled to the input terminal of the scaling circuitry and the output terminal of the third current mirror circuitry, the control terminal of the transistor coupled to the second output terminal of the second current mirror circuitry.

12. The apparatus of claim 8, wherein the scaling circuitry comprising:
a first transistor having a current terminal and a control terminal;
a second transistor having a current terminal and a control terminal, the current terminal of the second transistor coupled to the input terminal of the offset circuitry; and
trim circuitry having an output terminal coupled to the control terminal of the second transistor, the output terminal of the comparison circuitry, and the current terminal of the first transistor.

13. The apparatus of claim 8, wherein the error amplifier is first error amplifier, the offset circuitry comprising:
second error amplifier having an input terminal and an output terminal;
a resistor having a first terminal and a second terminal, the first terminal of the resistor coupled to the output terminal of the scaling circuitry and the input terminal of the second error amplifier; and
a transistor having a first terminal and a control terminal, the first terminal of the transistor coupled to the second input terminal of the comparison circuitry and the second terminal of the resistor, the control terminal of the transistor coupled to the output terminal of the second error amplifier.

14. The apparatus of claim 8, wherein the comparison circuitry is first comparator, the output terminal of the offset circuitry is a first output terminal, the offset circuitry further having a second output terminal, and the apparatus further comprising:
V-I converter circuitry having an input terminal; and
second comparison circuitry having a first input terminal and a second input terminal, the first input terminal of the second comparison circuitry coupled to the output terminal of the error amplifier and the input terminal of the V-I converter circuitry, the second input terminal of the second comparison circuitry coupled to the second output terminal of the offset circuitry.

15. An apparatus comprising:
switching converter circuitry configured to generate an output voltage responsive to an input voltage;
power saving mode (PSM) entry circuitry coupled to the switching converter circuitry, the PSM entry circuitry including:
comparison circuitry coupled to the switching converter circuitry, the comparison circuitry configured to compare the input voltage and the output voltage to select one of the input voltage or the output voltage;
scaling circuitry coupled to the comparison circuitry, the scaling circuitry configured to scale the one of the input voltage or the output voltage by a slope constant of the switching converter circuitry; and
offset circuitry coupled to the scaling circuitry, the offset circuitry configured to offset a reference compensation voltage by the one of the input voltage or the output voltage to generate a PSM entry voltage; and
comparison circuitry coupled to the offset circuitry, the comparison circuitry configured to compare a compensation voltage to the PSM entry voltage, the compensation voltage represents an error between the output voltage of the switching converter circuitry and a reference voltage.

16. The apparatus of claim 15, further comprising error amplifier coupled to the switching converter circuitry, the PSM entry circuitry, and the comparison circuitry, the error amplifier configured to generate the compensation voltage by determining a difference between the output voltage of the switching converter circuitry and the reference voltage, the reference voltage represents a target output voltage of the switching converter circuitry.

17. The apparatus of claim 15, wherein the PSM entry circuitry further including:
first voltage-to-current (V-I) converter circuitry coupled to the switching converter circuitry and the comparison circuitry, the first V-I converter circuitry configured to generate a first current that represents the input voltage of the switching converter circuitry; and
second V-I converter circuitry coupled to the switching converter circuitry and the comparison circuitry, the second V-I converter circuitry configured to generate a second current that represents the output voltage of the switching converter circuitry.

18. The apparatus of claim 17, wherein the comparison circuitry comprising:
first current mirror circuitry coupled to the first V-I converter circuitry, the first current mirror circuitry configured to replicate the first current;
second current mirror circuitry coupled to the second V-I converter circuitry, the second current mirror circuitry configured to replicate the second current;
third current mirror circuitry coupled to the first current mirror circuitry, the second current mirror circuitry, and the scaling circuitry, the third current mirror circuitry configured to generate a compensation current responsive to the first current being greater than the second current; and
a transistor coupled to the third current mirror circuitry and the scaling circuitry, the transistor configured to replicate the second current.

19. The apparatus of claim 15, wherein the scaling circuitry comprising:
a first transistor coupled to the comparison circuitry, the first transistor configured to source a current proportional to the one of the input voltage or the output voltage of the switching converter circuitry;
a second transistor coupled to the first transistor and the offset circuitry, the second transistor configured to source a scaled current representing the current proportional to the one of the input voltage or the output voltage times the slope constant; and
trim circuitry coupled to the second transistor, the trim circuitry configured to set the slope constant of the second transistor responsive to at least one of the switching converter circuitry or a derating value of an inductor.

20. The apparatus of claim 15, wherein the offset circuitry comprising:
error amplifier coupled to the scaling circuitry, the error amplifier configured to determine an error between the one of the input voltage or the output voltage and the reference compensation voltage;
a resistor coupled to the scaling circuitry and the error amplifier, the resistor configured to generate an offset voltage responsive to the one of the input voltage or the output voltage from the scaling circuitry; and
a transistor coupled to the error amplifier and the resistor, the transistor configured to supply an offset current to the resistor responsive to the error of the error amplifier.
